(19) United States
(12) Patent Application Publication
(10) Pub. No.: US 2011/0087988 A1
(43) Pub. Date: Apr. 14, 2011

(54) GRAPHICAL CONTROL ELEMENTS FOR BUILDING MANAGEMENT SYSTEMS

(75) Inventors: Beth A. Ray, Oak Creek, WI (US); Dimitrios S. Papadopoulos, Township of Washington, NJ (US); Sang Hoon Chung, Holland, MI (US); Grant Carmichael, Grand Rapids, MI (US); Joseph M. Mueller, Hales Corners, WI (US); Anne M. Kumor, Greendale, WI (US)

(73) Assignee: Johnson Controls Technology Company

(21) Appl. No.: 12/902,026

(22) Filed: Oct. 11, 2010

Related U.S. Application Data
(60) Provisional application No. 61/250,819, filed on Oct. 12, 2009.
(60) Provisional application No. 61/250,824, filed on Oct. 12, 2009.

(51) Int. Cl. G06F 3/048

(52) U.S. Cl. 715/771

(57) ABSTRACT

A building management system includes graphical control elements for viewing and interacting with the building management system. Graphical control elements conduct analysis of information received from the building management system and may be used to control building equipment, monitor operational statuses, diagnose faults, or conduct other building management system tasks.

### CROSS-REFERENCE TO RELATED APPLICATIONS

The present application claims the benefit of U.S. Provisional Application No. 61/250,824, filed Oct. 12, 2009, and U.S. Provisional Application No. 61/250,819, filed Oct. 12, 2009. The entireties of U.S. Provisional Application Nos. 61/250,824 and 61/250,819 are hereby incorporated by reference.

### BACKGROUND

The present invention relates generally to the field of building management systems.

A building management system (BMS) is, in general, a hardware and/or software system configured to control, monitor, and manage equipment in or around a building or building area. A BMS can include a heating, ventilation, and air conditioning (HVAC) system, a security system, a lighting system, a fire alerting system, an elevator system, a water management system, a food storage system, a telephone system, another system that is capable of managing building functions or devices, or any combination thereof. BMS devices may be installed in any environment (e.g., an indoor or an outdoor area) and the environment may include any number of buildings, spaces, zones, rooms, or areas. A BMS may include METASYS building controllers or other devices sold by Johnson Controls, Inc. as well as building devices and components from other sources.

A BMS may include one or more computer systems (e.g., servers, controllers, etc.) that serve as enterprise level controllers, application or data servers, head nodes, or master controllers for the BMS. Such computer systems may communicate with multiple downstream building systems or subsystems (e.g., an HVAC system, a security system, etc.) according to disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and its devices.

A conventional graphical user interface (GUI) for a BMS typically includes different spreadsheets, lists, or very simple graphics. These conventional user interfaces can be unintuitive for users and may not convey data in an manner that is meaningful to users without extensive training. If GUIs are overly simplified, they can be under utilized due to a lack of powerful features. It is challenging and difficult to develop useful, intuitive, and powerful graphical user interfaces for a BMS.

### SUMMARY

One embodiment of the invention relates to a system for displaying a graphical user interface for a building management system on an electronic display for a client device. The system includes a processing circuit configured to load and present a graphical control element within the graphical user interface. The processing circuit further includes (a) an input handler for the graphical control element that is configured to interpret user inputs received at the client device as commands for the graphical control element, (b) a data interface for the graphical control element that is configured to associate (e.g., bind, connect, etc.) the graphical control element with data from disparate building management system sources, and (c) a data analysis module for the graphical control element that is configured to use data from the data interface to perform at least one data analysis task. The processing circuit may further be configured to provide results of the data analysis task to the graphical control element for display on the electronic display.

Another embodiment of the invention relates to computer-readable media with computer-executable instructions embodied thereon. When the instructions are executed by a computer system, the computer system performs a method for displaying a graphical user interface for a building management system on an electronic display for a client device. The instructions embodied on the computer-readable media include instructions for loading and presenting a graphical control element within the graphical user interface. The instructions embodied on the computer-readable media also include instructions for providing an input handler configured to interpret user inputs received at the client device as commands for the graphical control element. The instructions embodied on the computer-readable media further include instructions for providing a data interface for the graphical control element configured to associate the graphical control element with data from disparate building management system sources. The instructions embodied on the computer-readable media yet further include instructions for providing a data analysis module for the graphical control element configured to use data from the data interface to perform at least one data analysis task. The instructions embodied on the computer-readable media also include instructions for providing results of the data analysis task to the graphical control element and causing the display of the results on the electronic display.

Another embodiment of the invention relates to a computerized method for displaying a graphical user interface for a building management system on an electronic display for a client device. The method includes loading a graphical control element within the graphical user interface. The method also includes interpreting user inputs received at the client device as commands for the graphical control element. The method further includes associating the graphical control element with data from disparate building management system sources. The method yet further includes performing at least one data analysis task on the graphical control element using data received from the disparate building system and using a data analysis module for the graphical control element. The method also includes the causing the data analysis module to provide the results of the data analysis task to the graphical control element and causing the display of the results on the electronic display.

Alternative exemplary embodiments relate to other features and combinations of features as may be generally recited in the claims.

### BRIEF DESCRIPTION OF THE FIGURES

The disclosure will be more fully understood from the following detailed description, taken in conjunction with the accompanying figures, wherein like reference numerals refer to like elements, in which:

FIG. 1 is a diagram of a BMS, according to an exemplary embodiment;

FIG. 2 is a detailed view of the GUI shown in FIG. 1, according to an exemplary embodiment;

FIG. 3 illustrates possible lines between services, modules, or activities handled by the client or one or more servers, according to an exemplary embodiment;

FIG. 4A is a block diagram of a processing circuit for the client of FIG. 1, according to an exemplary embodiment;

FIG. 4B is a block diagram of a client and a BMS server, according to an exemplary embodiment;

FIGS. 5A-F illustrate graphical control elements, according to varying exemplary embodiments;

FIGS. 6A-D are views of graphical control elements, according to varying exemplary embodiments;

FIG. 7 is a flow chart and corresponding illustration of a process for an exemplary graphical control element, according to an exemplary embodiment;

FIG. 8 is a flow chart and corresponding illustration of a process for another exemplary graphical control element, according to an exemplary embodiment;

FIG. 9 illustrates an exemplary graphical user interface showing a plurality of graphical control elements arranged together, according to an exemplary embodiment;

FIG. 10A is a flow chart of a process for providing a graphical control element to a BMS, according to an exemplary embodiment;

FIG. 10B is a flow chart of a process for completing user tasks at a graphical control element, according to an exemplary embodiment;

FIG. 10C is a flow chart of a process for providing on-demand or passive analysis of data related to a graphical control element, according to an exemplary embodiment;

FIG. 10D is a flow chart of a process for identifying data at the graphical control element, according to an exemplary embodiment;

FIGS. 11A-F are flow charts of a process for using graphical control elements to diagnose and correct a fault in a building management system, according to an exemplary embodiment;

FIG. 12 is a diagram of a BMS including a multi-touch display surface, according to an exemplary embodiment;

FIG. 13 is a diagram of a GUI for the BMS of FIG. 12, according to an exemplary embodiment; and

FIG. 14 is a diagram of the multi-touch display surface of FIG. 12 and various devices of the BMS, according to an exemplary embodiment.

### DETAILED DESCRIPTION OF THE EXEMPLARY EMBODIMENTS

The systems and methods of the present disclosure generally include a graphical user interface configured to host a graphical control element (GCE). The graphical control element of the present disclosure is intended to provide information from disparate BMS sources (e.g., security systems or devices, fire detection and warning systems or devices, surveillance systems or devices, HVAC systems or devices, etc.) in a consistent manner, regardless of the data source. Furthermore, some graphical control elements of the present disclosure are intended to provide enhanced information to a user based on analyzed or correlated data—rather than conventional systems that typically only display single value data in table or spreadsheet-style formats. A plurality of graphical control elements according to the present disclosure may be provided on (i.e., hosted within) a single GUI. The plurality of graphical control elements may be configured to follow a single unified theme (i.e., a designated set of colors, shapes, fonts, consistent GCE component locations, etc.) which is intended to contribute to a consistent look and feel for a BMS GUI. Some embodiments of the present disclosure are further intended to reduce a visual distinction between equipment information (i.e., an equipment based display) on the GUI and information calculated by a component of the GUI or another processing module of the BMS (i.e., a feature-based display).

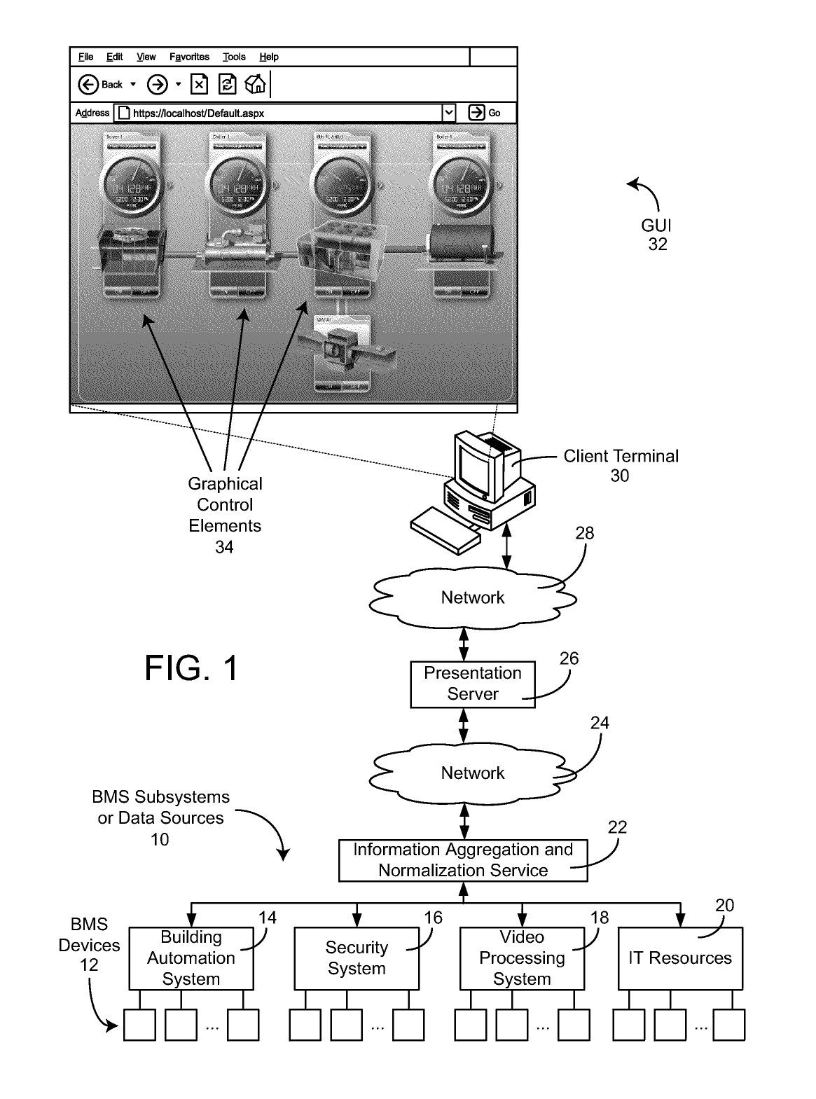

Referring now to FIG. 1, a diagram of a BMS is shown. The BMS may include various BMS subsystems or data sources 10 (e.g., building automation system 14, security system 16, video processing system 18, and IT resources 20). The BMS also includes a client terminal 30 having an electronic display on which GUIs such as the illustrated GUI 32 may be displayed. Client terminal 30 is configured to access BMS subsystems or data sources 10 via the illustrated networks 24, 28, presentation server 26, or information aggregation and normalization service 22. The GUIs provided to the electronic display of client terminal 30 are variously configured to allow users (e.g., building manager, building engineer, security manager, etc.) to monitor, configure, control, or otherwise affect the operation of the BMS. Client terminal 30 may be located at a user station, front desk, remotely from the building or site being managed, or any other area. In an exemplary embodiment, software of client terminal 30 may be configured to cause a GUI including, for example, illustrated GUI 32 and one or more GCEs 34 to be displayed.

GCEs 34 may be generated in response to user interaction with GUI 32, user interaction with another widget, an event being received by client 30 from the BMS, or otherwise. GCEs 34 may be one or more applications, applets, or “widgets” for display on GUI 32 and for providing a rendering of data provided by the BMS. Each graphical control element of GCEs 32 can include multiple user interface controls for receiving user input. Each graphical control element of GCEs 32 can also include multiple display elements such as streaming text, summary information, live video, graphics, graphs, or other displays generated using information from the BMS (e.g., BMS subsystems 10, information aggregation and normalization service 22, presentation server 26, etc.). Each graphical control element may be associated with at least one service, subsystem, feature, piece of equipment, or group of equipment of the BMS. Many of the graphical control elements shown in a GUI according to the present disclosure, however, will include summary information, fused information, aggregate information, or another combination of information from multiple services, features, or subsystems of the BMS.

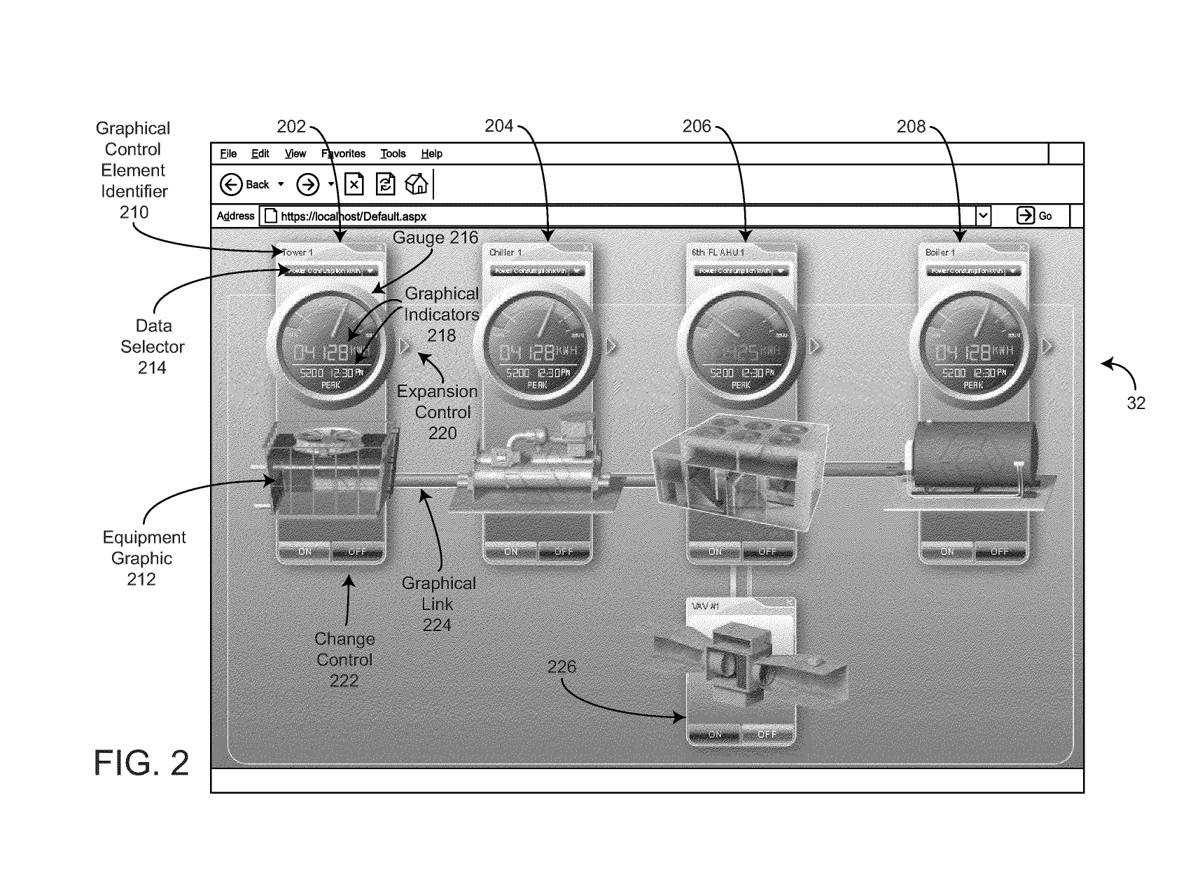

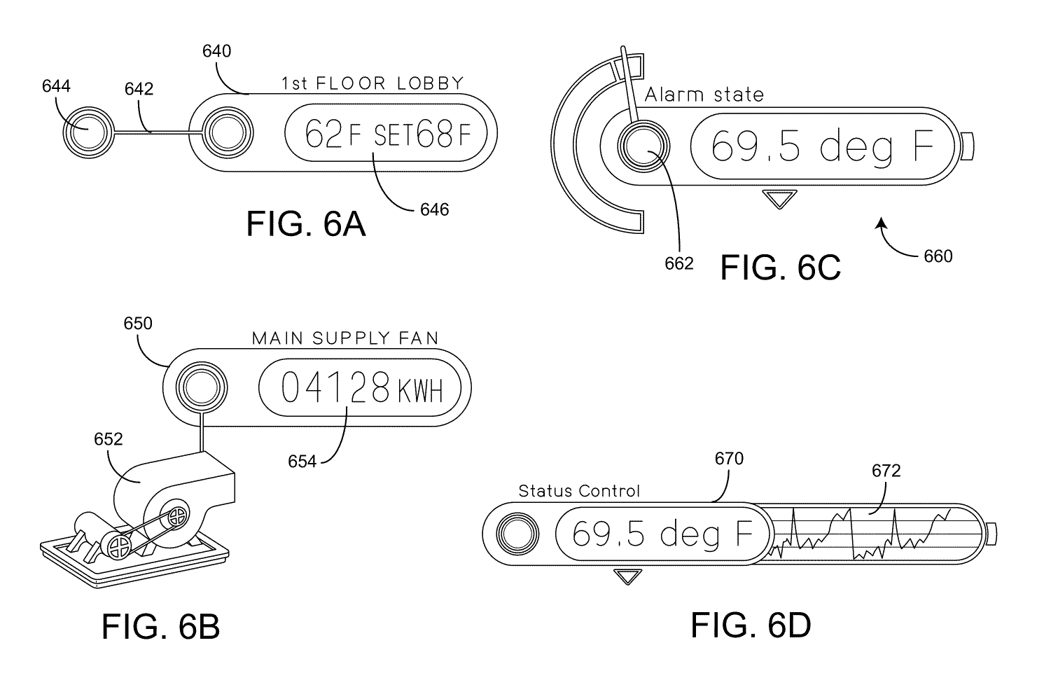

Referring now to FIG. 2, GUI 32 is shown to include graphical control element 202 which relates to a condenser tower, and other GCEs that relate to, respectively, a chiller (GCE 204), an air handling unit (GCE 206), a variable air volume box (GCE 226), and a boiler (GCE 208). Each graphical control element may include a graphical control element identifier 210, a data selector 214, a gauge 216, one or more graphical indicators 218 (e.g., within a gauge, within a pill-shaped GCE as shown in FIGS. 6D-6G, a graph of a trend, other trend information, alarm information, history information, current value information, a diagnostic result, etc.), an expansion control element 220, a graphic of the relevant equipment 212, a change control 222, and/or a graphical link 224 to another graphical control element. In various other embodiments, one or more of these aspects may be removed, multiplied, or otherwise modified relative to the embodiment shown in FIGS. 1 and 2. As shown in FIGS. 1 and 2, the graphical control elements may be linked together (e.g., graphically) to provide a user with a complete view of a system, feature, subsystem, or user-customized grouping of equipment. This linking or combination of graphical control elements for different pieces of equipment may advantageously allow a user to view “whole system” level information or to troubleshoot problems without having to spend time finding and inspecting multiple disparate data points.

In one embodiment, GCEs are able to perform multi-stage analysis on the data that it receives. For example, a GCE may analyze a plurality of data points to generate a statistical model to predict the behavior of one or more systems or pieces of equipment. New data points, such as real-time data from the BMS, can be analyzed using the predictive model to detect faults, drive diagnostics, or detect variations in the behavior of the BMS. For example, real-time power consumptions that fall outside of the predictive model may indicate that the model needs to be updated.

In another embodiment, the GCE can detect time series deviations, i.e. whether the current data deviates from a trend generated by the GCE using historical data. For example, an operating parameter that is found to be drifting away from a setpoint may indicate that a fault condition exists.

In yet another embodiment, GCEs can use a comparison between a predictive model and real-time data to generate an alert for another system (e.g., an equipment controller, a supervisory controller, a server, etc.) and/or a user. For example, the alert may contain preventative measures, maintenance tasks, or estimated cost information for replacing systems or equipment of the BMS.

In some embodiments, GCEs can receive raw data points directly from the BMS (i.e., without utilizing information and normalization service 22 and/or presentation server 26) and perform analysis on them at client 30 itself. For example, GCE 206 may aggregate data from BMS subsystems or data sources 10 or from BMS devices 12 (e.g., VAV 226, a temperature sensor, a damper position sensor or a pressure sensor) in building automation system 14. In this way, external data (e.g., real-time data) can be gathered at the GCE running on client terminal 30.

In other embodiments, GCEs are not a standalone application and are run within another software environment (e.g., run within another user application). For example, a webpage itself would not be a GCE, but GCEs may be run within a web browser and presented as being a part of a web application. In some embodiments, GCEs are launchable, closable and/or movable within the software environment.

In yet other embodiments, GCEs represent physical or virtual devices in the BMS. For example, GCE 226 may represent a VAV box for an an air handling unit (e.g., GCE 206) or a conference room being conditioned by the AHU GCE 206. In this way, GCE 34 can represent building objects that are interrelated using a hierarchy or causal relationship model (e.g., an “ontological” model). Building objects related by a causal relationship model are further described in U.S. application Ser. No. 12/898,589, filed Oct. 5, 2010, the entirety of which is hereby incorporated by reference. In this way, the causal relationships can be used to link, call and pass parameters between GCEs. For example, an AHU GCE may use causal relationships to call other related GCEs (e.g. GCEs representing dampers, valves, sensors, etc.). In another example, a fault indicator on an AHU GCE can be updated using data from a damper GCE that indicates that a fault condition exists in the damper.

GCEs 202, 204, 206, 208, 226 shown in FIGS. 1 and 2 may be referred to as equipment-based GCEs that are configured to summarize, analyze, or present information for a piece of equipment or system. Equipment-based GCEs are relevant to a specific type of equipment and/or configuration of that equipment. The equipment-based GCEs may correlate or analyze the data to determine, for example, the operating condition of the equipment compared to expected operation—presenting the result with a simplified graphical indicator (e.g., a gauge with colors, tick points, needles, a graph, etc.). In various exemplary embodiments the equipment-based GCEs are also configured to allow a user to interact with the equipment. The interaction may be allowed by presenting the user with, for example, change controls, value boxes and update-buttons, or other user interface features for receiving user input regarding setting information (e.g., desired setpoint). The graphical control elements having a simplified graphical indicator and one or more change controls may allow the user to monitor, command, and control the system or piece of equipment without requiring the user to have in-depth knowledge of the many data points that relate to the system or equipment.

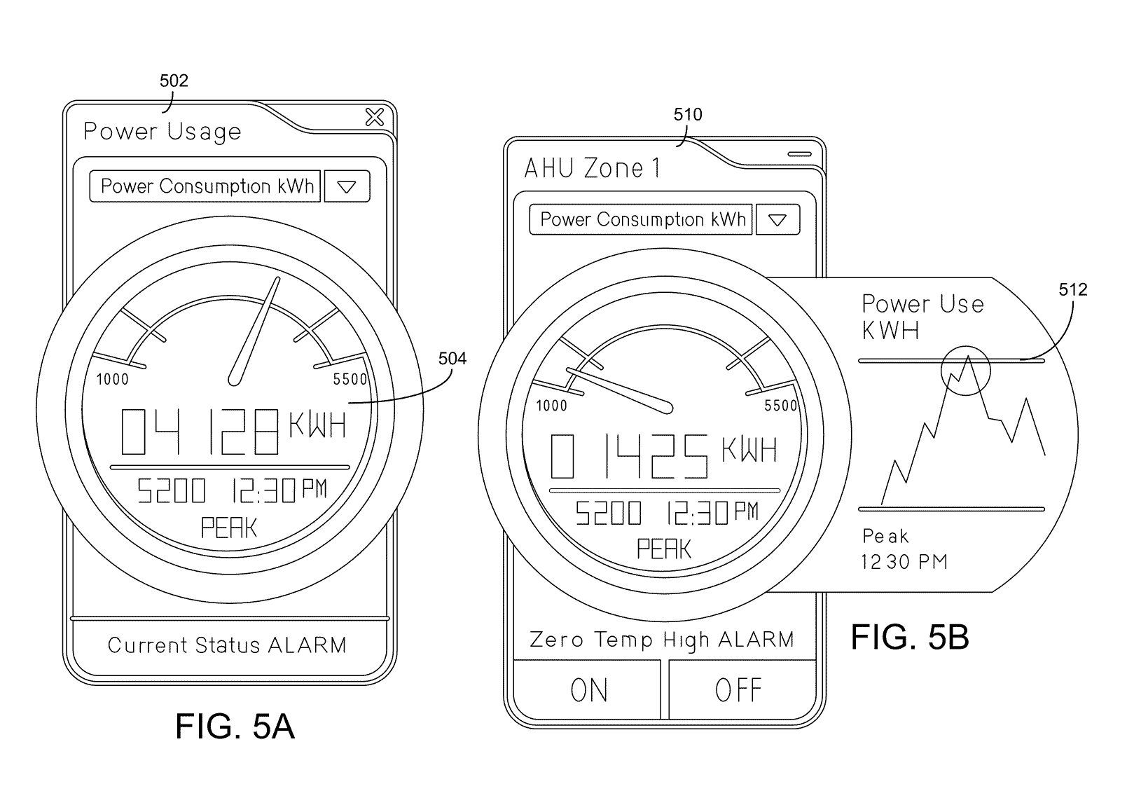

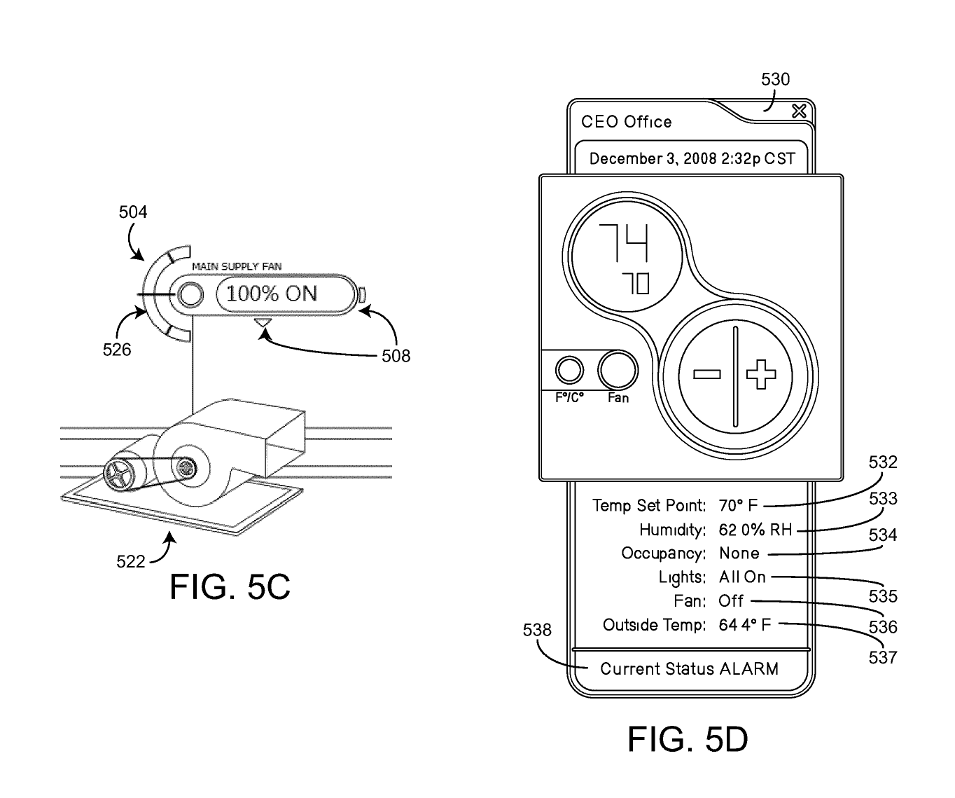

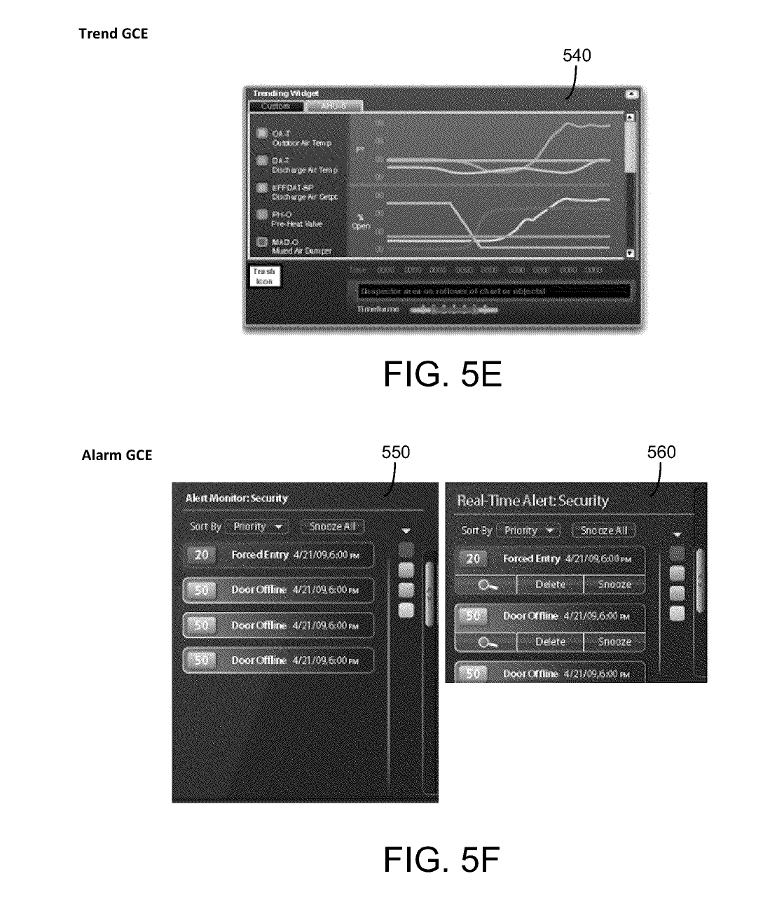

Feature-based graphical control elements (examples shown in FIGS. 5E-F) may also be provided to graphical user interfaces and by systems and methods of the present disclosure. A feature-based graphical control element may summarize information associated with one or more features not tied to a single piece or group of equipment. For example, a feature-based graphical control element may be configured to provide event management, security management, energy management, or other features spanning multiple pieces of equipment or systems. A feature-based graphical control element advantageously may receive or gather data otherwise “scattered” throughout a system, process the data, and provide a simplified interface to the data available from all of the components that contribute to the features.

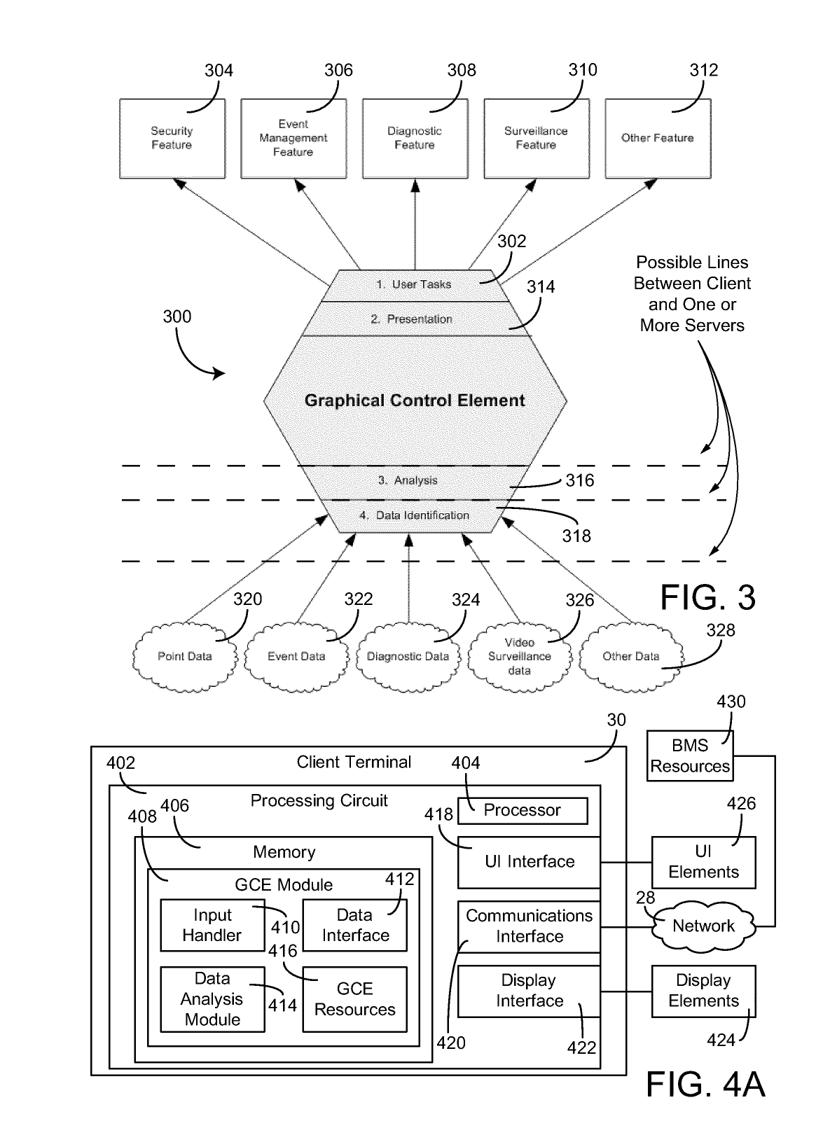

Referring now to FIGS. 1 and 3, presentation server 26, information aggregation and normalization service 22, or a combination thereof may be configured to conduct one or more activities of GCE 300. For example, a service 302 for handling user input, a presentation service 314 (e.g., preparing, loading, rendering graphical control elements), a data analysis service 316, a data identification service 318, or other services may be spread throughout the BMS between client terminal 30, presentation server 26, and information aggregation and normalization service 22. FIG. 3 illustrates some possible lines between services, modules, or activities handled by the client or one or more servers, according to varying exemplary and alternative embodiments. FIG. 3 also illustrates multiple features 304, 306, 308, 310, 312 (e.g., that may be provided by one or more graphical control elements of the present disclosure through visual indicators or controls) and multiple different data types 320, 322, 324, 326, 328 or sources for the graphical control elements.

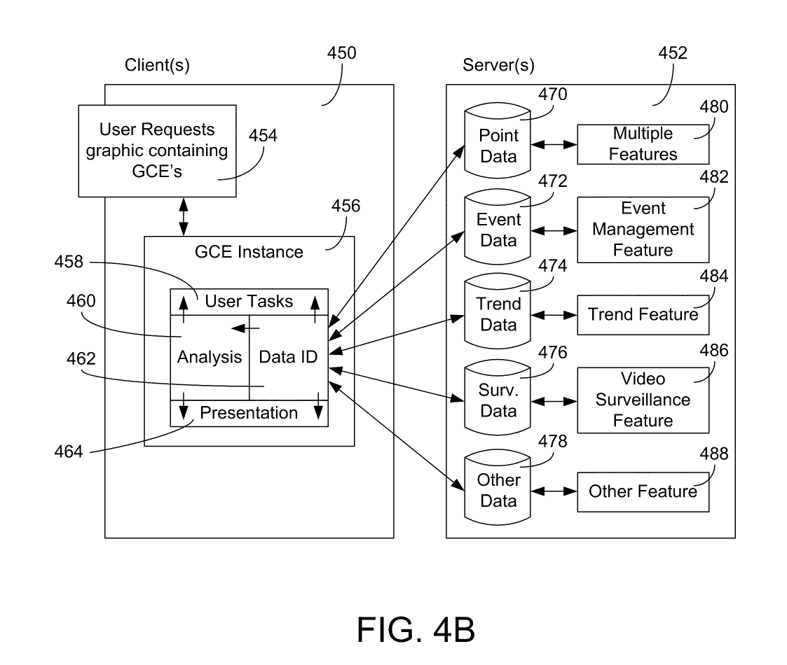

Referring now to FIG. 4A, a block diagram of a processing circuit for client terminal 30 of FIG. 1 is shown, according to an exemplary embodiment. Client terminal 30 in FIG. 4A is shown to include a processing circuit 402 (i.e., processing electronics) including a processor 404 and memory 406. Processor 404 may be a general purpose or specific purpose processor configured to execute computer code or instructions stored in memory 406 or received from other computer readable media (e.g., CDROM, network storage, a remote server, etc.). Memory 406 may be RAM, hard drive storage, temporary storage, non-volatile memory, flash memory, optical memory, or any other suitable memory for storing software objects and/or computer instructions. When processor 404 executes instructions stored in memory 406 for completing the various activities described herein, processor 404 generally configures client terminal 30 and more particularly processing circuit 402 to complete such activities. Said another way, processor 404 is configured to execute computer code stored in memory 406 to complete and facilitate the activities described herein. Memory 406 is shown to include modules which are computer code modules (e.g., executable code, object code, source code, script code, machine code, etc.) configured for execution by the processor. Processing circuit 402 may include other hardware circuitry for supporting the execution of the computer code of memory 406. As previously mentioned, in various exemplary embodiments one or more of the components of FIG. 4A may be distributed to presentation server 26 or another server and work in conjunction with, e.g., a browser on client terminal 30.

Processing circuit 402 generally and memory 406 more particularly are shown to include GCE module 408. GCE module 408 may include computer code instructions, and may be an instantiated object, a computer code class, or otherwise configured to load and present a graphical control element within a graphical user interface shown on an electronic display system (e.g., display elements 424). GCE module 408 is shown to include an input handler 410 configured to interpret user inputs received at client 30 via UI interface 418 as commands for the graphical control element. GCE module 408 is further shown to include data interface 412 configured to associate (e.g., bind, connect, etc.) the graphical control element with data from disparate BMS sources. GCE module 408 further includes data analysis module 414 configured to use data from data interface 412 to perform at least one data analysis task. GCE module 408 or another module or process of processing circuit 402 is configured to provide results of the analysis task to display interface 422 for display on display elements 424.

GCE module 408 is further shown to include GCE resources 416. GCE resources 416 may include common graphics (e.g., boundary graphics, theme graphics, fonts, etc.) configured to be used by one or more graphical control elements. If GCE resources 416 are common they may be separate from any particular GCE module of a plurality of GCE modules. Processing circuit 402 is further shown to include UI interface 418. UI interface 418 may include computer code instructions or hardware circuitry or other components (e.g., a USB jack) for receiving signals from UI elements 426 (e.g., touch screen sensors, a mouse, a keyboard, a microphone for voice recognition, etc.). Signals received from UI elements 426 may be converted into events or other representations or descriptions of the user input for providing to input handler 410.

Processing circuit 402 is yet further shown to include communications interface 420 which may include computer code instructions, hardware circuitry or other components (e.g., an Ethernet jack, a WiFi transceiver, etc.) for communicating with a network 28 having or connected to BMS resources 430 (e.g., a presentation server, a data server, a BMS controller, etc.). Processing circuit 402 is further shown to include display interface 422. Display interface 422 may include computer code instructions, hardware circuitry, or other components (e.g., an DVI jack, an HDMI jack, an analog display output, etc.). GCE module 408, a general purpose process of processing circuit 402, or other components of client terminal 30 may be configured to provide display interface 422 with the graphics (e.g., bit maps, video, etc.) for display on one or more display elements 424 (e.g., touchscreens, LCD monitors, etc.). In various embodiments processing circuit 402 may further include a controller or set of control modules for the BMS (e.g., a Johnson Controls Metasys controller) or one or more particular control modules for a BMS subsystem (e.g., a security system, an HVAC system, etc.).

Referring now to FIG. 4B, a block diagram of a client 450 and a BMS server 452 are shown with arrows for data flow, according to an exemplary embodiment. When a user requests a GCE or data from a GCE at block 454, GCE instance 456 may present available user tasks or other output up to the user via a user display interface 458. When inputs from the user are received, the GCE instance may identify and gather pertinent data via data identifier or interface 462. An analysis module 460 may be executed uses the pertinent data from one or more data resources on a BMS server. Results of the analysis or data identification are presented to the user at a presentation layer 464. Data resources (e.g. point data 470, event data 472, trend data 474, surveillance data 476, and other data 478) on server 452 may communicate with processes (e.g., multiple features 480, event management feature 482, trend feature 484, video surveillance feature 486, and other feature 488) on one or more servers. Server features 480, 482, 484, 486, 488 may be configured to aggregate data, conduct actual equipment control activities, manage events, calculate or otherwise identify trends, etc. for use with GCE instance 456. Advantageously, GCE instance 456 includes an analysis module 460 which can use the numerous or disparate data received at data interface 462 from server 452. In a conventional system, all of the analysis would occur on server 452 and only input and display tasks could be conducted by any given graphical control element.

Referring now to FIGS. 5A-F various graphical control elements are shown, according to an exemplary embodiment. For example, FIG. 5A is a graphical control element 502 configured to receive usage information from BMS equipment or subsystems and to display aggregate power consumption or usage via graphics 504 or other indicia (e.g., text readings) on graphical control element 502. Some GCEs may receive BMS information from one piece of equipment, one BMS subsystem, one feature, or display one set or type of data values. The GCE of FIG. 5A analyzes usage information from a plurality of BMS data sources and shows an aggregate value. The information from the plurality of BMS data sources or the aggregate value is further analyzed by an analysis module of GCE 502 to determine how to communicate a current status to a user. In the example of FIG. 5A, an analysis module of GCE 502 has determined that the current status should list “ALARM.” A conventional BMS client application would typically pull the status from a server.

FIG. 5B is a graphical control element 510 configured to allow a user to explore power consumption associated with a particular AHU. Although GCE 510 relates to a single piece or set of equipment, the information may be drawn from multiple disparate data sources. For example, GCE 510 may receive actual energy used by a fan motor associated with the AHU as well as sensor information or setpoint information for other AHU parts (e.g., sensors, actuators, etc.). GCE 510′s analysis module may use the received data to conduct a series of calculations configured to estimate the energy use over a period of time. The energy use is displayed as trend graph 512. The need for displaying an alarm state may be analyzed by GCE 510. Further, the trend graph 512 or the underlying data for trend graph 512 may be analyzed by GCE 510 to determine whether to highlight a region. As shown in FIG. 5B, a spike in power use is circled as a result of analysis by GCE 510. As shown, the analysis may include graphical display relative to a threshold or horizontal bar.

Referring now to FIG. 5C, a graphical control element of a different shape and design relative to the GCEs of FIGS. 5A and 5B are shown. GCE 504 of FIG. 5C illustrates a piece of equipment (e.g., a main supply fan) and includes a line connecting the illustration of the piece of equipment to a “pill-shaped” graphical control element. GCE 504 is equipment based (e.g., associated with a main supply fan). GCE 504 is also a “value box” GCE—a GCE that is configured to allow a user to view and adjust a value tied to a piece of equipment. The value is illustrated within the “pill” portion as well as the fan's state (e.g., on, off, energy-saving, etc.). The same or another value as that shown within the “pill” may be graphically illustrated by a gauge 526 or other indicia. The “pill” is further shown as having or being connected to an associated equipment graphic 522 (e.g., a 3d-look graphic of the main supply fan). GCE 504 (and other exemplary GCEs) can include expansion controls 528. An input handler for GCE 504 may be configured to respond to user interaction with expansion controls 528 by, for example, expanding a trend graph (as illustrated in FIG. 6D) when the expansion control to the side of the “pill” is clicked. In other embodiments, additional values or options relating to the equipment may be displayed when the expansion control beneath the “pill” is clicked or otherwise selected.

GCE 530 of FIG. 5D is shown to include an illustration of a physical thermostat or temperature sensor. GCE 530 may be configured to change a temperature setpoint for a building space based on user input (e.g., rotation of the plus/minus wheel, clicking on the plus, clicking on the minus, etc.). GCE 530 of FIG. 5D may show readings from a plurality of sensors or processing algorithms which may draw information from multiple disparate data points. For example, GCE 530 is shown to include temperature setpoint 532, current temperature 531, humidity 533, occupancy 534 (e.g., whether the space is occupied or not), lights 535 (e.g., whether the lights are on), fan status 536, outside temperature 537, and status indicator 538. Status indicator 538 may be set by an analysis module of GCE 530 and after analyzing the varying data of information 532-537 as received from a plurality of BMS sources.

FIG. 5E is a feature-based graphical control element 540 configured to use information (e.g., temperature sensor inputs, trending calculations, normalization calculations) to present a graph of the information over time.

FIG. 5F illustrates two exemplary graphical control elements 550, 560 for monitoring alarms or other events from BMS features or equipment (e.g., a plurality of security devices in a building).

In FIGS. 6A-6D, views of additional “pill-shaped” graphical control elements are shown, according to varying exemplary embodiments. FIG. 6A is a feature-based GCE 640 for a first floor lobby and contains temperature information 646. GCE 640 may include a graphic of a line 642 connecting the “pill” to point 644. Point 644 may identify a building space relating to the values reported by feature-based GCE 640. For example, point 644 may overlay a floor plan (e.g., flat, three-dimensional, etc.) of a room (e.g., first floor lobby) and serve as a graphical indication of the relationship between GCE 640 and the room.

FIG. 6B is an equipment-based GCE 650 for a main supply fan 652 and is currently showing energy usage 654 for supply fan 652. FIG. 6C is a “pill-shaped” GCE 660 having a gauge 662 with a needle showing the temperature for a building space or equipment as being within an alarm state. Comparing the temperature for a building space with a scale or alarm threshold may be an example of an analysis conducted by GCE 660. FIG. 6D illustrates a “pill-shaped” GCE 670 with a trend graph 672 expanded from GCE 670.

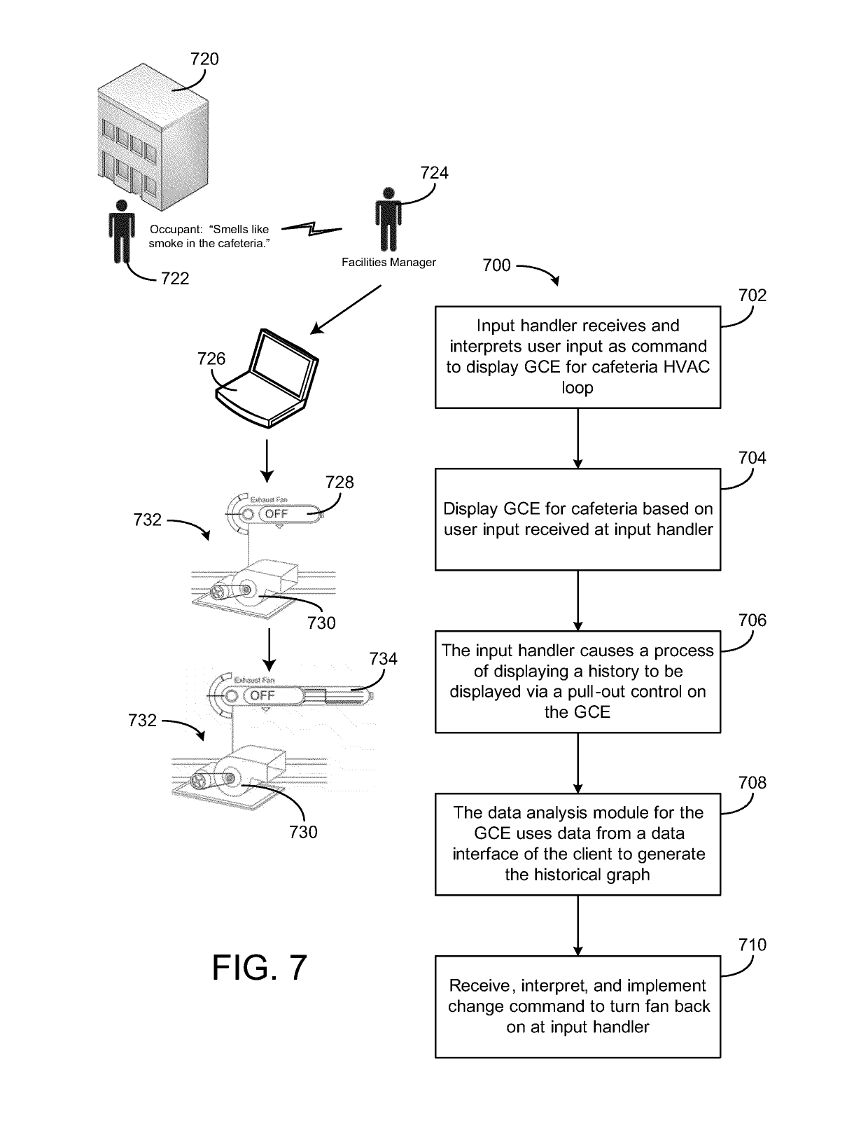

Referring now to FIG. 7, a flow chart and corresponding illustration of a process 700 for an exemplary GCE 732 is shown, according to an exemplary embodiment. Occupant 722 communicates to facilities manager 724 that a potential fault exists in the cafeteria of building 720 (e.g., the occupant may complain that the building space of the cafeteria smells like smoke). Facilities manager 724 then uses client 726 to evaluate the cafeteria's HVAC system. Client 726 is configured to allow facilities manager 724 to view and interact with the HVAC system via GCE 732 to complete process 700. GCE 732 may have an exhaust fan portion 730 and attached “pill” portion 728 that provides status information about the associated exhaust fan. For example, facilities manager 724 can select the right side of “pill” portion 728 to display historical graph 734 to view historical information about fan 730. Facilities manager 724 may also use GCE 732 to interact with the HVAC equipment (e.g., issue a change command to turn fan 730 back on at the input handler).

Process 700 is implemented by client 726 and GCE 732. Process 700 includes receiving a user input at an input handler and interpreting the user input as a command to display a GCE for the cafeteria HVAC loop (step 702). Process 700 also includes displaying GCE 732 for the cafeteria based on user input received at the input handler (step 704). Process 700 further includes the input handler causing history 734 to be displayed via a pull-out control on GCE 732 (step 706), e.g., in response to a user selecting the right side of the pill-shaped graphic. Process 700 yet further includes the data analysis module of GCE 732 using data from a data interface of client 726 to generate history 734 (step 708). Finally, process 700 is shown to include receiving, interpreting, and implementing a change command to turn fan 730 back on at the input handler (step 710).

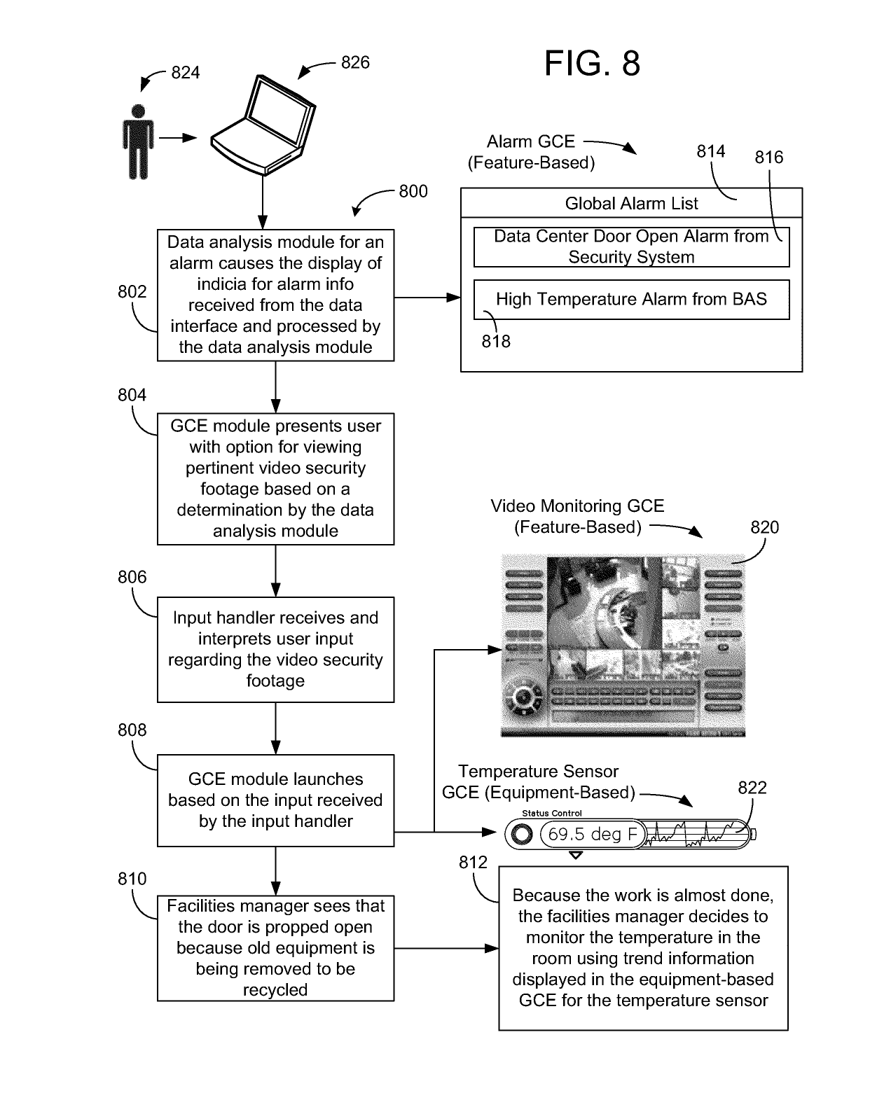

Referring now to FIG. 8, a flow chart and corresponding illustration of a process 800 for another exemplary graphical control element is shown, according to an exemplary embodiment. Facilities manager 824 interacts with client 826, which displays GCEs. Process 800 includes the data analysis module for an alarm (e.g. alarm GCE 814) causing the display of indicia for alarm info received from the data interface and processed by the data analysis module (step 802). GCE 814 is an alarm list including a security alarm 816 and a temperature alarm 818. GCE 814 may analyze BMS alarms to determine ordering in the list. Security alarm 816 corresponds to a secured door being open and temperature alarm 818 corresponds to a high temperature in the building automation system. GCE 814 may present the facilities manager 824 with options for viewing pertinent video security footage based on a determination by GCE 814′s data analysis module (step 804). User inputs to GCE 814 are then received and interpreted by the input handler of GCE 814 regarding the video security footage (e.g., the user opts to view the video) (step 806). GCE 814 then launches another GCE module (e.g., video monitoring GCE 820 or temperature sensor GCE 822) based on the inputs received by its input handler (step 808). GCEs 820, 822 aggregate information about the various components of the building automation system and allow facilities manager 824 to monitor and interact with their respective components. For example, video monitoring GCE 820 may aggregate video feeds from multiple security cameras and allow facilities manager 824 to view current or historical information about the video feed of the secured door. Facilities manager 824 then sees that the door is propped open because old equipment is being removed to be recycled (step 810). Having viewed the state of the secured door, facilities manager 824 decides to monitor the temperature in the room using trend information displayed in temperature sensor GCE 822 (step 812).

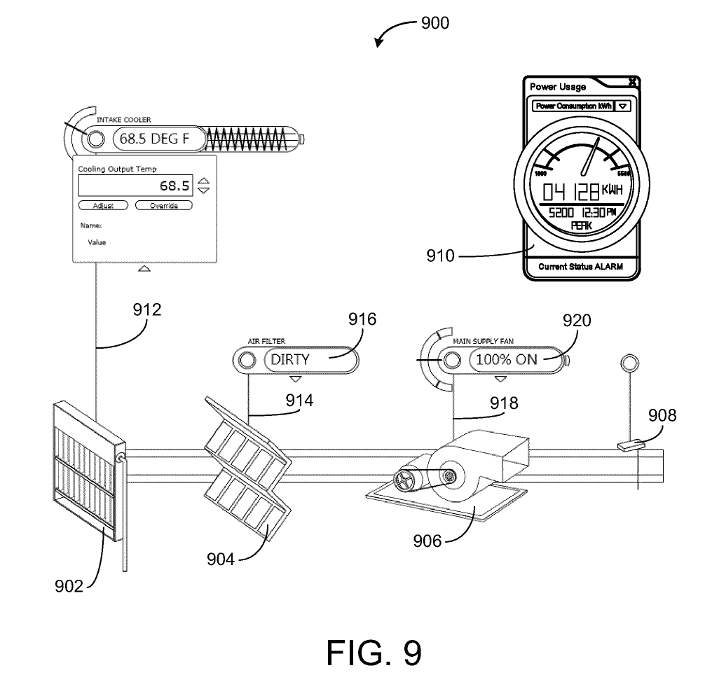

Referring now to FIG. 9, an exemplary graphical user interface showing a plurality of graphical control elements arranged together is shown, according to an exemplary embodiment. GUI 900 shown in FIG. 9 may be launched by a user based on user input received at a GCE (e.g., the global alarm list GCE 814 shown in FIG. 8). GUI 900 (or other detailed views) may be shown to further describe the equipment, features, or subsystems, relating to other GCEs, graphics, or other controls shown in the GUI. The arrangement shown in FIG. 9 may be created based on a computerized process that determines subsystems and features based on stored relationship information. In other embodiments, the arrangement shown in FIG. 9 may be created via user input received at a configuration tool. Memory 406 shown in FIG. 4A (or memory of another computer system) may include a configuration module configured to provide a GUI for allowing a user to select graphical control elements from a plurality of possible graphical control elements and to drag (or otherwise place) the selected graphical control elements onto the GUI scene. Using this process, the user may continue to add relevant GCEs to the control system “scene.” The user may select equipment GCEs or feature-based GCEs. In the exemplary embodiment shown in FIG. 9, a user (or a computerized process) has constructed a GUI scene including an equipment-based GCE 902 for an intake cooler, an equipment based GCE 904 for an air filter, an equipment-based GCE for a main supply fan 906, an equipment based GCE 908 for a temperature sensor, and a feature-based GCE 910 for calculating power usage. By connecting GCEs 902, 904, 906, 908 (e.g., via their placement in one scene, by a user drawing lines connecting the GCEs such as lines 912 914, 918, by ordering the GCEs via a list, etc.) the configuration module may be configured to create or update a relationship model stored in memory of the client or in memory of a server or BMS controller. The relationship model may be used by the feature-based GCE 910 related to the scene. For example, GCE 910 may analyze (e.g., aggregate power, determine an alarm state, etc.) based on the stored relationship model. The stored relationship model may also be used by a control algorithm for the subsystem to relate all of the equipment to the same building space (e.g., a cafeteria, a library, etc.), or for other control purposes.

The relationship model created by linking GCE's may be used by an aggregation process associated with a GCE to determine a set of data for further processing or for future use by the GCE. For example, the relationship model may be used to determine which of multiple data sets or data values are to be included in or “rolled up” to a calculation or grouping for a particular piece of equipment, view level, BMS subsystem, user selection or other grouping. Further, the relationship model may be used by a data or graphical navigation feature of a GCE. For example, the user may be able to click on or otherwise interact with a graphic, button, hyperlink or other indicia on the GCE to obtain more information about equipment, features, subsystems or values. The input handler or another process of a GCE may respond to such a request by parsing or otherwise using the relationship model to determine the next navigation step or to, e.g., render a hierarchical tree of GCEs, equipment names or the like. For example, receiving input at a higher level GCE may cause one or more lower level GCEs to be displayed. FIG. 2 illustrates an example of such a navigation. Clicking on the AHU graphic of the AHU GCE may cause a GCE for a VAV that is a part of the AHU to be launched or otherwise displayed.

In other embodiments, the linking is for purely graphical illustration purposes and is intended to create an easy to understand scene for the user to control. In an exemplary embodiment the various scenes created by a user may be saved with names, in a list, or as “favorites” such that a user can “flip through” or otherwise browse the scenes later. A part of the configuration process that the configuration module may prompt the user to undertake or that a computerized process may take is binding a selected and dragged GCE to particular equipment, systems, or other resources. The binding process may be used by the configuration module to store references to data points that the GCE will display or use in data analysis activities, aggregation activities, or navigation activities.

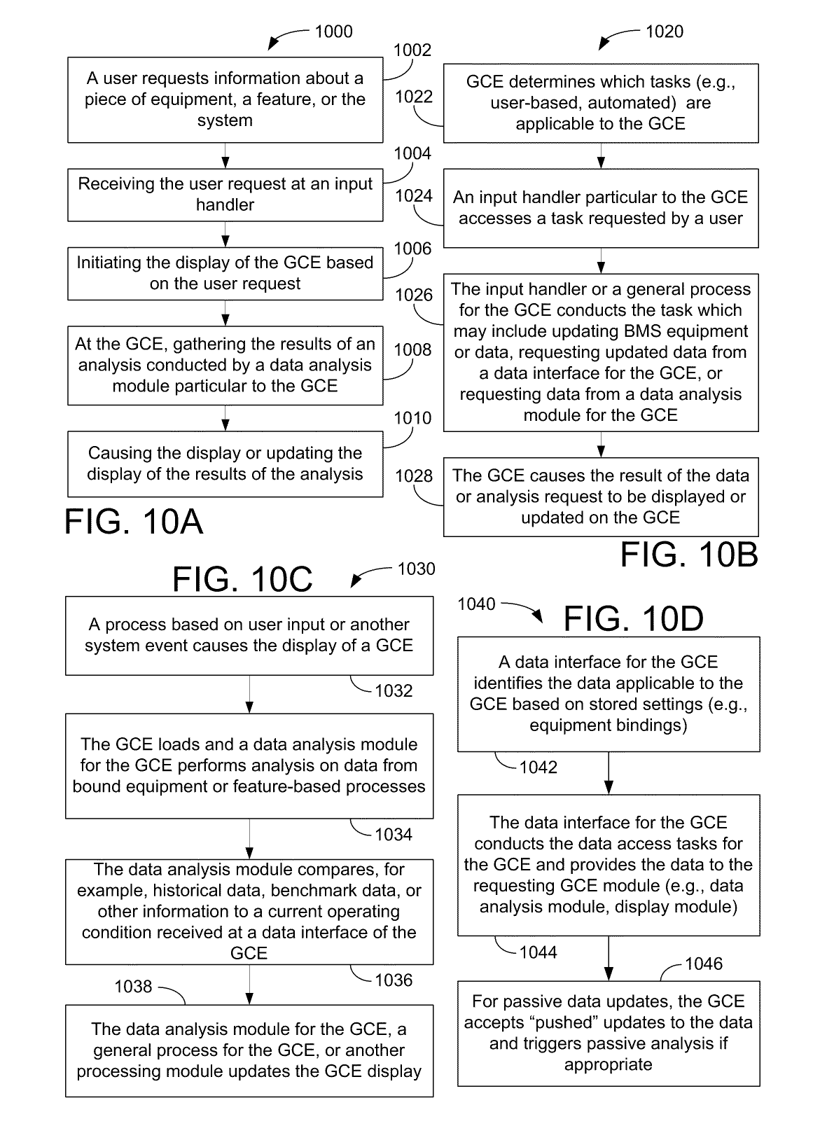

Referring now to FIG. 10A, a process 1000 for providing a GCE to a BMS GUI is shown, according to an exemplary embodiment. Process 1000 is shown to include a user requesting (e.g., via a user activity such as a click, a gesture, etc.) information about a piece of equipment, a feature, or the system (step 1002). Process 1000 also includes receiving the user request at an input handler (e.g., a general input handler for the client GUI, an input handler particular to the GCE, etc.) (step 1004). Process 1000 further includes initiating the display of the GCE based on the user request (step 1006). When the GCE is opened, rendered, or otherwise activated, the GCE gathers results of an analysis conducted by a data analysis module particular to the GCE (step 1008). The data for the GCE may be received or gathered by a data interface particular to the GCE. The GCE then causes the display of the results or updates the display of the results (e.g., a current operation condition or historical analysis of the equipment, feature, or system) (step 1010).

Referring now to FIG. 10B, a flow chart of a process 1020 for completing user tasks at a GCE is shown, according to an exemplary embodiment. Process 1020 is shown to include the GCE (e.g., a general processing module thereof, an initial function called during loading of the GCE, etc.) determining which tasks (e.g., user-based tasks, automated tasks, etc.) are available or applicable to the GCE (step 1022). An input handler particular to the GCE accesses the task (e.g., parses the task request, assesses the task in light of data or equipment bound to the GCE, etc.) (step 1024). The input handler or another process for the GCE (e.g., a main process) drives or conducts the task, which may include updating BMS equipment or data, requesting updated data from a data interface for the GCE, or requesting data from a data analysis module of the GCE (step 1026). Process 1020 further includes causing the result of the data or analysis request to be displayed or updated on the GCE (step 1028).

Referring now to FIG. 10C, a flow chart of a process 1030 for providing on-demand or passive analysis of data related to the GCE is shown, according to various exemplary embodiments. Process 1030 is shown to include displaying the GCE based on user input or another system event (step 1032). The GCE loads and a data analysis module for the GCE performs analysis on data from bound equipment or feature-based processes (step 1034). The analysis can be based on user request (on-demand analysis) or a computerized determination (a passively triggered analysis). The data analysis module may compare, for example, historical data, benchmark data, or other information to a current operating condition received at a data interface of the GCE (step 1036). The data analysis module for the GCE, a general process for the GCE, or another processing module updates the GCE display (step 1038).

Referring now to FIG. 10D, a flow chart of a process 1040 for identifying data at the GCE is shown, according to an exemplary embodiment. Process 1040 includes a data interface for the GCE identifying the data applicable to the GCE based on stored settings (e.g., equipment bindings, subscribed variables, subscribed services, etc.) (step 1042). The data interface for the GCE conducts the data management tasks for the GCE (e.g., data query, data lookup, etc.) and provides the data to the requested GCE module (e.g., data analysis module, display module, etc.) (step 1044). For passive data updates (those not requested by a user), the GCE accepts “pushed” updates to the data and triggers “passive” analysis (an analysis not requested by a user) if further analysis of the data is appropriate (a determination made by a module or process of the GCE or flagged with the received data) (step 1046).

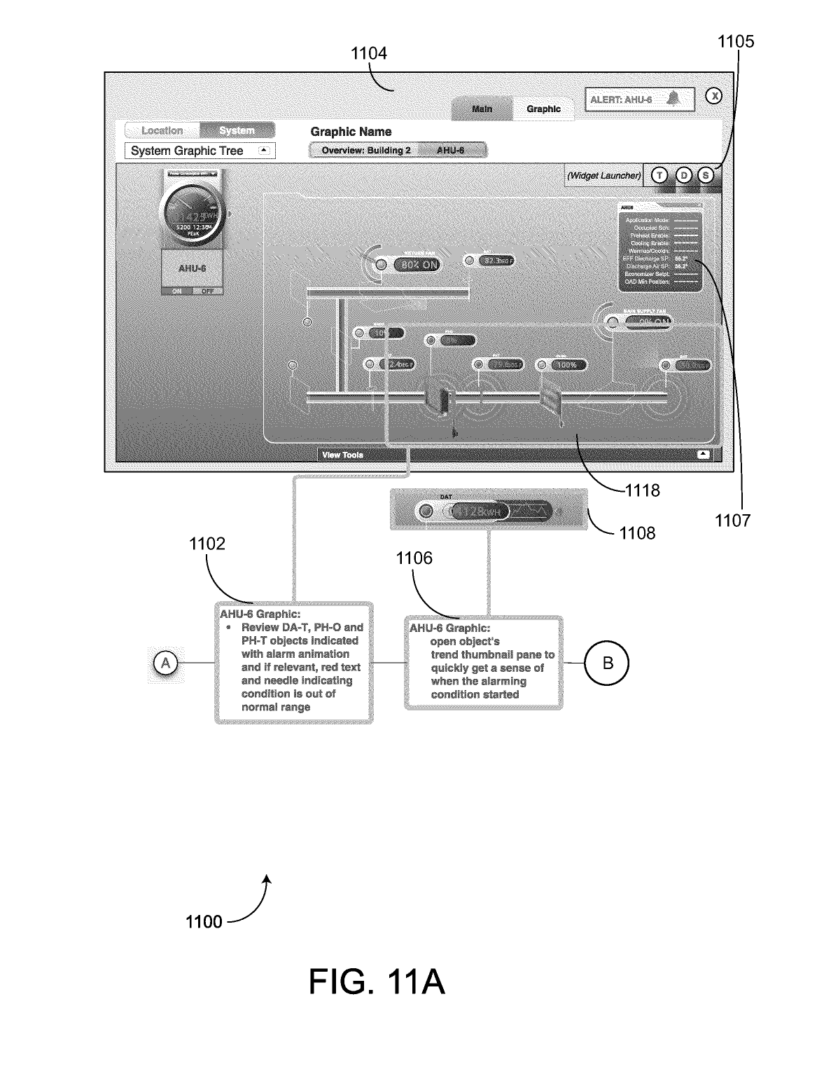

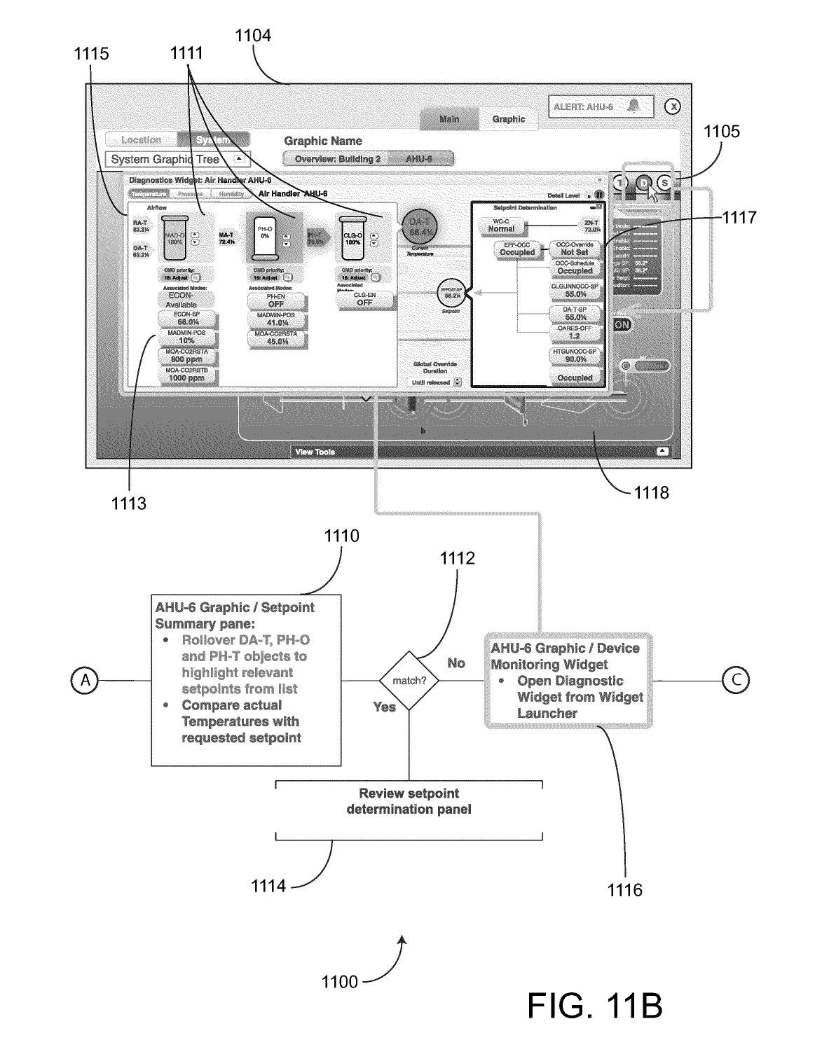

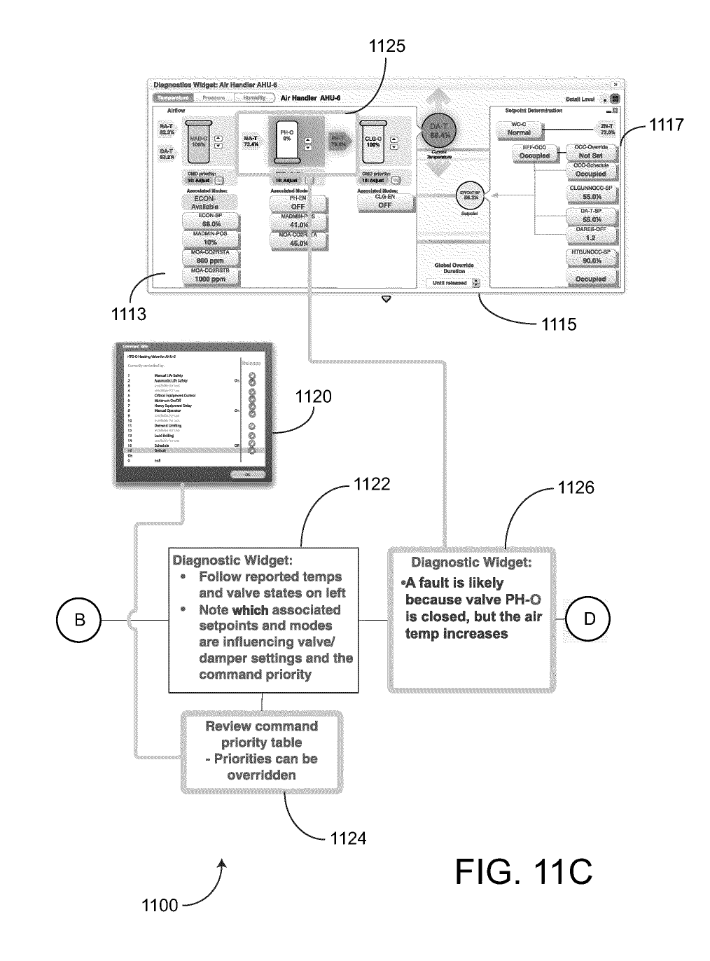

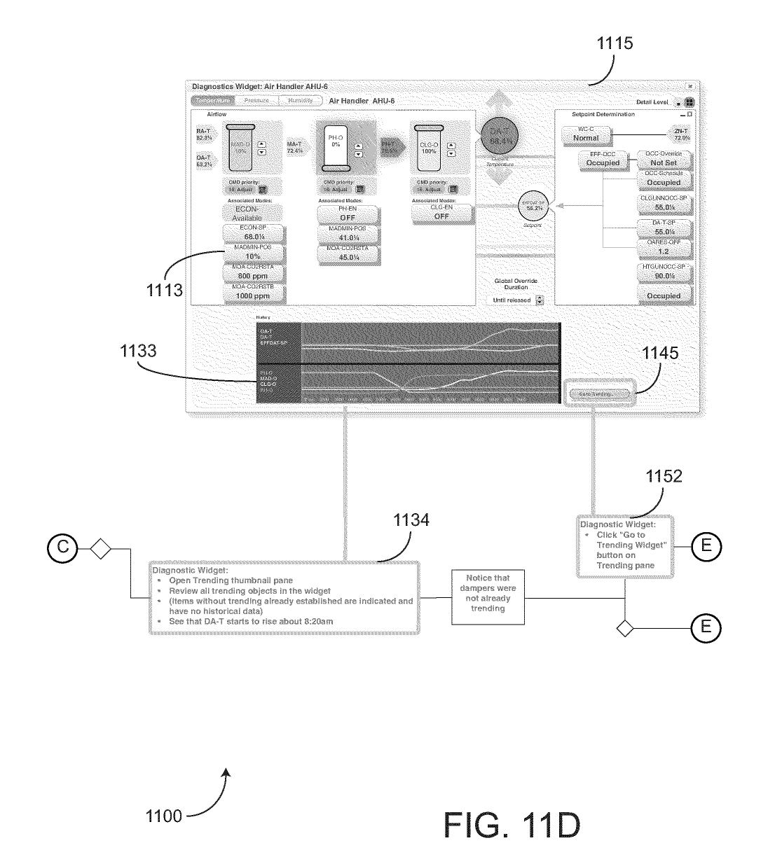

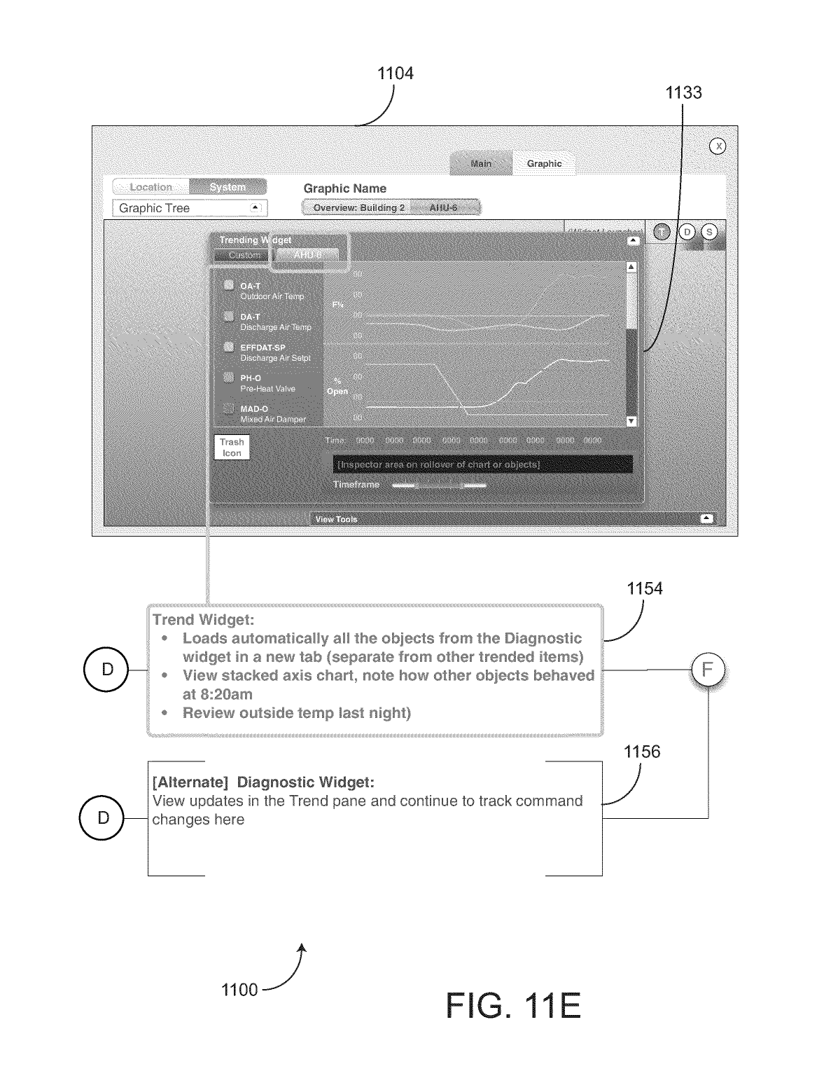

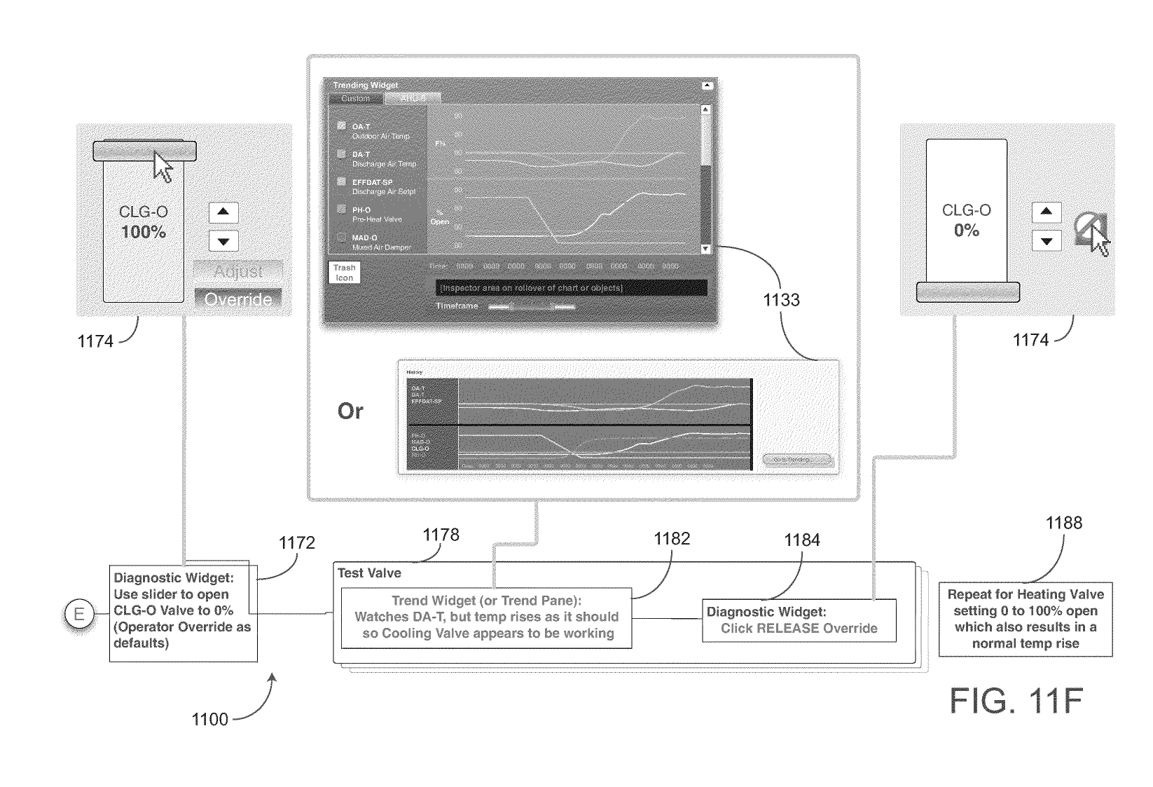

Referring now to FIGS. 11A-F, flow charts of processes for using graphical control elements to diagnose and correct a fault in a building management system are shown, according to an exemplary embodiment. Process 1100 in FIG. 11A illustrates the operations multiple GCEs via a possible user scenario. View 1104 is presented on the display and contains multiple AHU GCEs 1118 relating to an AHU. GCEs 1118 display fault indicia (e.g., animations, text, red coloring, etc.) indicating that a fault exists in the HVAC system. At step 1102 of process 1100, a user reviews AHU GCEs 1118 displayed in view 1104, including the indicia that a fault condition exists.

In some embodiments, the fault data is generated by AHU GCEs 1118 locally on the client using an analysis module and data received from the BMS (e.g., raw data, analyzed data, smoothed data, etc.). For example, a GCE may receive real-time data relating to the condition of the AHU and conduct an analysis to determine that a fault condition exists by comparing the real-time data to one or more behavior models or trend data.

At step 1106, the user may select a GCE in AHU GCEs 1118 to view a history graph of one or more parameters associated with the HVAC equipment. GCE 1108 is configured to receive a user request (e.g. a mouse click over an arrow located on its right side). GCE 1108 interprets the user input, retrieves a history of the one or more parameters of the equipment associated with GCE 1108, generates a history graph using the history of parameters, and displays the graph as a “slide out” graphic on the display. Compiling the history using received information may be one example of analysis conducted at GCE 1108 (as opposed to a history compilation conducted or driven by a server).

View 1104 is shown to contain a widget launcher 1105 that is configured to launch additional GCEs in response to user input. Widget launcher 1105 may launch a diagnostic GCE based on a user clicking the diagnostic button abbreviated as “D.” View 1104 also includes a setpoint summary panel GCE 1107. Setpoint summary panel GCE 1107 displays information about the current setpoints of the AHU's components. In some embodiments, setpoint summary panel GCE 1107 is also configured to allow user interaction either directly or through AHU GCEs 1118. For example, setpoint summary panel GCE 1107 may highlight or display additional information about a setpoint in response to a request from the user (e.g., a user performs a mouse rollover of a GCE in AHU GCEs 1118).

Referring now to FIG. 11B, process 1100 is shown to include step 1110, where the user interacts with view 1104. At step 1110, the user may use a pointing device to rollover AHU GCEs 1118 and to view various setpoint information in setpoint panel GCE 1107. At step 1112, the user determines a course of action based on the reviews of step 1110. If the equipment is operating at or near its setpoints, the faults may be due to the setpoints being set improperly. However, if the setpoints and the actual values do not match, the fault may be due to an equipment failure. In either case, the user may launch a diagnostic widget (e.g., diagnostic GCE 1115), as in step 1116. If the equipment is operating near a setpoint, the user may review setpoint determination pane 1117 to review what other data or commands are used to determine the potentially incorrect setpoint (step 1114).

Diagnostic GCE 1115 is shown to include equipment diagnostic GCEs 1111. Equipment diagnostic GCEs 1111 are configured to retrieve and display diagnostic related information. For example, various operating parameters 1113 (e.g., measured temperatures, pressures, etc.) may be displayed by equipment diagnostic GCEs 1111. In some embodiments, equipment diagnostic GCEs 1111 may be interrelated such that status information and other parameters may be shared between multiple equipment diagnostic GCEs. For example, the set of equipment diagnostic GCEs 1111 may include a GCE for each piece of equipment that affect temperatures in the AHU, i.e. mixed air damper output “MAD-O,” preheat valve “PH-O,” and cooling valve “CHG-O.” Equipment diagnostic GCEs 1111 may be arranged according to the physical layout of the underlying equipment or in a manner based on stored causal relationships. Equipment diagnostic GCEs 1111 may also perform analysis on shared information such that a change in a parameter for one GCE triggers one or more changes in another GCE. For example, “PH-O” may receive temperature data from the BMS and analyze the data to determine that a temperature-related fault exists in the underlying equipment. “PH-O” may also provide an alert to “DA-T,” that a fault condition exists. Discharge air temperature “DA-T” may analyze this alert to determine if the alert is above a specific severity threshold. In this way, higher level GCEs can filter out minor alerts from lower level components. If the alert received from “PH-O” is severe, “DA-T” may alter its indicia to also indicate a fault condition (e.g., a change in color, presentation of text, etc.).

In step 1122 in FIG. 11C, the user can follow reported temperatures and valve states on the left side of diagnostic GCE 1115 (e.g. parameters 1113). The user may then note what associated setpoints and modes are influencing the valve/damper settings (e.g. setpoint panel GCE 1107) and command priority 1120. Command priority 1120 may be called by diagnostic GCE 1115 or another GCE in response to user input and controls the order of preference for the various types of commands. At step 1124, the user can review command priority 1120 and/or override priorities. At step 1126, the user may also note that the air temperature rises when passing through PH-0 (e.g. diagnostic GCE 1125), even though that status of GCE 1125 indicates that its valve is closed.

Referring now to FIG. 11D, diagnostic GCE 1115 is shown to include an embedded trending GCE 1133. Trending GCE 1133 can be displayed as embedded in diagnostic GCE 1115 via user input to diagnostic GCE 1115. Trending GCE 1133 can also be launched as a stand-alone widget via input to widget launcher 1105 shown in FIG. 11A. Trending GCE 1133 is configured to retrieve and display historical trend data based on a user's selection of equipment GCEs 1111. Alternatively, if trending GCE 1133 is launched from view 1104, AHU GCEs 1118 may populate trending GCE 1133 in response to user input. When trending GCE 1133 is associated with other GCEs (e.g. GCEs 1111, 1118, etc.), it retrieves historical data from the GCEs and uses the historical data to populate and display one or more trend charts. In other embodiments, the historical data is received by trending GCE 1133 from the BMS and may include real-time data to update the chart when new real-time data becomes available.

In step 1134 of process 1100, the user interacts with diagnostic GCE 1115 to open trending GCE 1133 as a thumbnail pane within diagnostic GCE 1115. The user is then able to review the trending objects and see that one of the positions of a damper begins rising at a specific time. In one embodiment, one or more GCEs may be configured to analyze the trend data to automatically detect changes in behavior of the system. In another embodiment, trending GCE 1133 may use linear regression or interpolation to analyze the trend data and to predict a future behavior of the system. For example, trending GCE 1133 may analyze trend data relating to a temperature and determine that the temperature is trending away from a setpoint. In this way, trending GCE 1133 may also take preventative measures, such as initiating diagnostics, providing an alert to a user, or notifying the BMS. Additionally, trending GCE 1133 may display the predicted behavior (e.g., as a dashed line, a transparent overlay, etc.) in addition to displaying the trend data.

At step 1152, the user may select a “Go to Trending Widget” button 1145 to view trending GCE 1133 in greater detail. Alternatively, the user can continues to view trending GCE 1133 as an embedded pane within diagnostic GCE 1115.

Referring now to FIG. 11E, at step 1156 of process 1100, the user continues to track changes through trending GCE 1133. If the user selected button 1145, trending GCE 1133 may be reloaded in a larger view (e.g., step 1154).

Referring now to FIG. 11F, GCEs 1111 in FIG. 11B is shown in greater detail. GCE 1174 may be part of diagnostic GCE 1115. GCE 1115 is configured to receive input from a user (e.g., via a sliding bar) that establishes a new setpoint for the valve associated with GCE 1174. Such input indicates that the user has chosen to override the current setpoint. An input that overrides a current setpoint can be used by GCE 1174 to generate and display new indicia to denote that the setpoint is being overridden.

Process 1100 is shown in FIG. 11F as including step 1172, where the user uses the slider in GCE 1174 to override its setpoint and assign a new setpoint. In step 1178, the user may view trending GCE 1133 to ensure that the system responds to the new setpoint as expected. For example, the user may verify that the “DA-T” temperature rises as expected (step 1182). If it does, the user may then release the overridden setpoint using GCE 1174 (step 1184). Finally, the user may repeat steps 1172 and 1178 to test other equipment, such as a heating valve (step 1188).

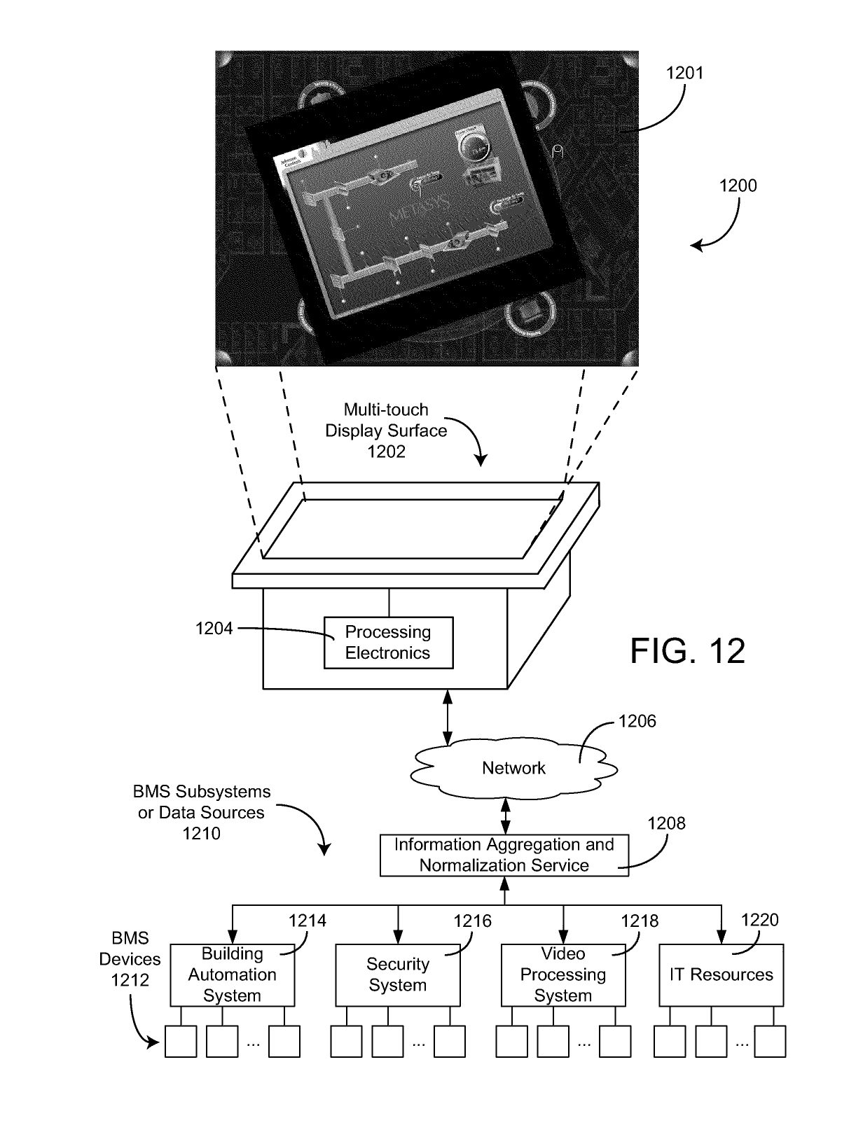

Referring generally to FIGS. 12-14, systems and methods for providing a graphical user interface or control activities for a BMS using a multi-touch display surface is shown. Referring now to FIG. 12, a diagram of a BMS 1200 is shown. BMS 1200 includes a table having a multi-touch display surface 1202 on which GUIs such as the illustrated GUI 1201 may be displayed. Processing electronics 1204 in or otherwise connected to multi-touch display surface 1202 are configured to access the BMS subsystems or data sources 1210 or BMS devices 1212 connected to the subsystems via network 1206. The GUIs provided to multi-touch display surface 1202 are variously configured to allow users (e.g., building manager, building engineer, security manager, etc.) to monitor, configure, control, or otherwise affect the operation of BMS 1200. GUI 1201 is shown to include BMS content which may include graphics and text descriptive of BMS 1200. Particularly, the embodiment shown in FIG. 12 includes a BMS GUI (e.g., BMS environment, multi-touch GUI environment, etc.) in which the BMS content of an HVAC control window has been loaded. The HVAC control window is shown as a METASYS control window, but may be a GCE, window, or other GUI element for controlling HVAC equipment or systems. In other exemplary embodiments the BMS content may be or include security monitoring or control content, energy efficiency and sustainability control content, chiller control content, or other building-related control content (e.g., scheduling, lighting, etc.).

Referring still to FIG. 12, multi-touch display surface 1202 and associated processing electronics 1204 may be configured to simultaneously load and display multiple BMS content windows, GCEs, or other controls and to allow the multiple BMS content windows, GCEs, or other controls to be interacted with simultaneously. Multi-touch display surface 1202 and associated processing electronics 1204 may be configured to distinguish touches in one area of the surface from touches in another area using one or more input handler processes. If the touches are determined to be discrete—not related to a single gesture (explained below)—then the one or more input handler processes may separately and simultaneously (e.g., near simultaneously, simultaneously to the human eye, etc.) cause corresponding actions in response to the separate touches in the separate BMS content windows.

Multi-touch display surfaces may be configured to interpret the multiple-touches as “gestures” (i.e., multiple touch combinations or movements that are identified as particular user interface commands). The gestures may include an “orbit” gesture (e.g., two fingers placed at any distance apart and rotated about the wrist axis at any speed initiates the chosen image to rotate in-place at a speed equivalent to the hand motion), a “drag” gesture (e.g., one or more fingers moved in the same direction initiates the chosen image to move in the direction and speed as the fingers), a “pinch” gesture (e.g., two fingers moved together from each other initiates the chosen image to zoom out), a “spread” gesture (e.g., two fingers moved away from each other initiates the image to zoom in), etc. It should be noted that velocity or acceleration of the touch movement may be detected by the multi-touch surface and result in different GUI behaviors. For example, if a window or object is touched and “swept” toward the edge of the screen at a relatively high speed, the processing electronics for the multi-touch display may animate a scene whereby the window or object disappears off the screen (effectively hiding or closing the window or object from view).

The table having multi-touch display surface 1202 may be located at a user station, front desk, remotely from the building or site being managed, or any other area. While multi-touch display surface 1202 is shown as a table-top, multi-touch display surface 1202 may be oriented as a wall, diagonally, or otherwise.

Processing electronics 1204 coupled to multi-touch display surface 1202 may be or include the primary BMS controller (e.g., a METASYS building controller sold by Johnson Controls, Inc.). In other embodiments, processing electronics 1204 serve as or include a client of a primary BMS controller or a system of BMS controllers. As shown in FIG. 12, processing electronics 1204 may communicate with BMS subsystems or data sources 1210 via an information aggregation and normalization service 1208. Information aggregation and normalization service 1208 may be configured to process disparate data received from various BMS subsystems or data sources 1210 (e.g., building automation system 1214, security system 1216, video processing system 1218, IT resources 1220, etc.) and BMS devices 1212 and make aggregated, normalized, or otherwise accessible information available to processing electronics 1204.

Referring further to FIG. 12, multi-touch display surface 1202 and processing electronics 1204 are configured to allow for multiple users to interact with BMS subsystems, features, or equipment using the same physical screen (i.e., the multi-touch display surface). For example, in an exemplary embodiment multiple building security-related windows or objects may be shown on GUI 1201 of multi-touch display surface 1202. One of the screens may relate to alarm conditions, a first camera view, or otherwise and may be monitored and interacted with by a first security personnel. Another of the screens may relate to a particular occupant that another security personnel is tracking through a building via a second camera view, floor plan view, or otherwise. In another exemplary embodiment, an HVAC professional may be troubleshooting a temperature problem on a first UI on the multi-touch display screen while a security professional is handling security events or alarms on a second UI on the multi-touch display screen. When two security professionals are working in two different windows on the same multi-touch display screen, one of the security professionals may cause his or her view to zoom-in (e.g., via a spread gesture) while another of the security professionals may maintain his or her view as zoomed-out to see the “big picture” of a building, floor plan, or otherwise. Unlike multi-monitor security systems, these activities may be simultaneously occurring on the same multi-touch display screen. In other words, the multi-touch feature may be used to expand one portion of a BMS display screen without affecting another user's portion. In yet other embodiments, when events or alarms are received, the system may be configured to cause one portion of the screen to automatically zoom-in (e.g., geolocation information is used by the processing electronics to command a zoom-in of a floor-plan or another building representation (e.g., three dimensional, a video scene, etc.)). When a representation of a building (e.g., two dimensional, three dimensional, etc.) is shown on the multi-touch display surface, the representation may be navigated via gestures. For example, if an alarm is occurring with a building, a wireframe or partial-cutaway view of the building may be shown with a red dot flashing. Processing electronics 1204 may provide this graphic or overlay using geolocation information about the alarm (e.g., the floor, the room, a specific coordinate, GPS information, etc.). The user may use a gesture to “zoom into” the building with gestures to see exactly where the alarm is occurring. As the building is zoomed into, additional geolocation information or additional building information may be brought into view by processing electronics 1204. For example, once an individual floor is essentially shown in one screen, room names and room data may be shown. Once an individual room is primarily shown in the zoomed in view, every “connected” BMS device within the room may be shown (e.g., in name, via an icon, on a video camera, etc.). Users can rotate the a room or floor using multi-touch gestures. In some embodiments the scene created will be created via “stitched video” or an “immersive display” of actual video information.

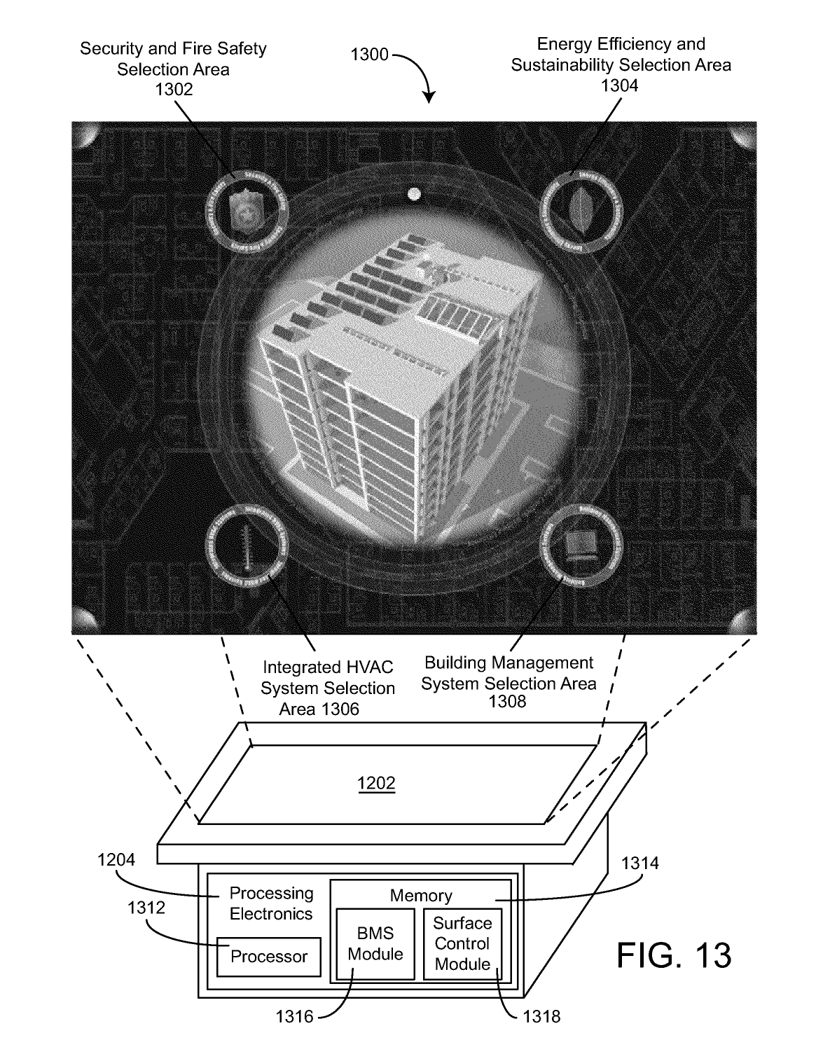

Referring now to FIG. 13, a BMS GUI 1300 is shown that may be used as the “root menu,” background, or other environment from which to launch BMS content. Text is displayed as wrapped around a circle. The building in the center (which may be an interactive graphic of the building being managed) and the text may be caused to rotate by processing electronics 1204. This rotation may advantageously allow multiple individuals standing around multi-touch display surface 1202 to see the text or building periodically directed toward their viewpoint.

In an exemplary embodiment the data is caused to be displayed on multi-touch display surface 1202 in multiple layers. Via the rotation, the outermost layer (e.g., relative to the center of the display surface) is intended to be equally visible from any perspective circumnavigating the display device. The four outer control areas (e.g., security and fire safety selection area 1302, energy efficiency and sustainability selection area 1304, integrated HVAC system selection area 1306, building management system selection area 1308) may include rotating graphics and text. Further, the areas may be tapped, spread, or otherwise touched to cause a control window, GCE, or other GUI control set for the associated BMS function to be loaded and displayed. The building in the center can be rotated, spread, or otherwise translated via the touch gestures. In an exemplary embodiment the outer selection areas are spaced equidistant from the center of the display surface or the nearest corner. This configuration may advantageously create a consistent appearance from multiple vantage points.

Using rotation of graphics, text, and launched control windows processing electronics 1204 and multi-touch display surface 1202 may be configured to provide for varying user perspectives (e.g., view angles and varying horizontal/vertical orientations). For example, processing electronics 1204 and multi-touch display surface 1202 may be configured to detect an input at the multi-touch surface and to correlate the input to the rotation of one of the selection areas 1302-1308. Processing electronics 1204 may initially display the new window or object on the GUI according to the correlation. In various embodiments the correlation may be based on detecting the time of the touch relative to the rotation of the text, proximity sensors, or the angle that the touch is coming from (e.g., using vision sensors, pressure sensors, etc.). In yet other embodiments, the windows are launched based on a previously used rotation angle or are launched according to a standard rotation angle. Once the window or object is initially launched it may be rotated via user gestures.

In an exemplary embodiment, a computerized method is provided (e.g., in the processing electronics) for providing a graphical user interface to multiple-users located around a multi-touch surface and viewing the multi-touch surface from different perspectives. The method includes rotating indicia including at least one of text and icons for a building management system function on the graphical user interface to orient the indicia for viewing from the different perspectives. The indicia may be or include components of the multiple selection areas. Each of the multiple selection areas may be configured to control (e.g., launch, initiate, display, etc.) a different building management system function (e.g., security, HVAC, etc.). As shown in FIG. 13, the multiple selection areas may be spaced around a large center area of a graphical user interface and the large center area may contains at least one of a two-dimensional floor plan and a three-dimensional representation of a building space. The displayed floor plan or other representation of the building space may also be rotated for viewing and interaction by multiple users around a multi-touch display surface. In other embodiments the large center area may include critical security footage (e.g., of a main entrance), summarize building events (e.g., alarms, temperature abnormalities), and include a main schedule for the building (e.g., of the heating, cooling, security locks, etc.). In an exemplary embodiment as shown in FIG. 13, the large center area is, includes, or is bounded by a large circle around which the multiple selection areas 1302-1308 are spaced equidistantly. As shown in FIG. 13, the multiple selection areas include four double-ringed circles. In other embodiments, the selection areas may be more rings, no-rings, be numbered as more than four, be numbered at less than four, or may be user configurable (e.g., the user may setup a dozen selection areas for launching various GCEs). When the selection areas are touched, multiple widgets, GCEs, windows, etc. or other GUI objects may be launched on the same multi-touch display surface. The multiple GCEs may be retained on the same display screen for interaction by multiple users (e.g., multiple security personnel). Each of the double-ringed circles may include rotating text (or other indicia) describing the BMS function associated with the selection area. One or more edges of the four double-ringed circles may intersect edges of the large circle. As shown in FIG. 13, the large circle may be a double-ringed circle. In an exemplary embodiment, the computerized method includes detecting an input at the multi-touch surface and correlating the input to the rotation of the indicia. The method further includes displaying a new window or object on the graphical user interface according to the correlation.

In various embodiments, each of the selection areas around the large circle may relate to a different building and the GUIs may relate to a campus or other enterprise. Processing electronics 1204 for multi-touch display surface 1202 may be or be coupled to an enterprise level BMS controller. For example, one or more facility managers for a campus (or multiple campuses) may use multi-touch display surface 1202 for enterprise-wide control activities. The selection areas may open windows or controls for particular buildings, subsystems, or portions of the enterprise. One application module of processing electronics 1204 may be a resource scheduling module. At an enterprise-wide command center having multi-touch display surface 1202, the multiple users managing the enterprise may be able to view alarms, events, situations, or the like from the enterprise level and schedule their limited human or equipment resources (e.g., service personnel, service trucks, etc.) to handle certain tasks prior to others. The multi-window, multi-control, and multi-user interface may advantageously provide an enterprise command center with a better perspective and with an ability to “drill down” into situations in great detail—features that are currently not available in conventional enterprise control systems. Further, multi-touch display surface 1202 may be configured to display multiple alarms for multiple buildings at the same time. A plurality of the alarms and the buildings may be investigated simultaneously by different users. These features may also be provided to other remote operations center (ROC) environments (e.g., network management, dispatch management, etc.).

In an exemplary embodiment, a control GUI for a chiller such as user interfaces and/or control algorithms provided by the “Optiview” line of chiller controllers sold by Johnson Controls, Inc. may be displayed as a window or via GCEs shown on multi-touch display surface 1202. In other embodiments, commissioning tools or design tools for a BMS may be provided by processing electronics 1204 and multi-touch display surface 1202 described herein. For example, one or more “layers” of a floor plan may be worked on at once on multi-touch display surface 1202. A plumber, a wireless communications expert, an electrician, an HVAC planner, or other design professionals may work around a large table or wall in which multi-touch display surface 1202 is embodied. These designers may each have a “toolbox” or one or more other UI windows from which to select components for their systems. By dragging the desired components to, e.g., a floor plan or map, multiple designers may collaboratively plan a floor, building space, building or other environment simultaneously. Once one designer has completed adding devices to a portion of the map, one of the users may rotate the display so that the next user can add his or her components. The designers are able to resolve differences “on the fly” using a common plan rather than disparate “hardcopies” or CAD files.

In a multi-user environment with one or more of the users having different roles, processing electronics 1204 may be configured to distinguish between users or distinguish between user locations. For example, multi-touch display surface 1202 may be configured to divide the table or wall of the surface into logical slices and a user may “log into” a slice—signaling that they will be working at a physical location with respect to the rest of the table or users. In other embodiments, the “log-in” is automatic or detected (e.g., processing electronics 1202 and multi-touch display surface 1204 are configured with fingerprint recognition logic, a camera provides facial recognition, voice recognition is used, etc.). Whether automatic or manual logins are used, processing electronics 1204 may be configured to change contexts or environments for a certain “slice” of multi-touch display 1202 based on the user identification. For example, once a user logs into the system, his or her presets may be accessed by processing electronics 1204 and used to, e.g., set a font, set a font size, set a theme, provide a “bookmarked” or “default” view for the user, provide the user with messages or alarms particular to that user, etc. In other embodiments the identification of the user is completed by processing electronics 1204 to set the permissions for the user. When unauthorized users or users with relatively low permissions are standing around multi-touch display surface 1202, processing electronics 1204 may restrict the permissions for the entire table until the unauthorized user steps away from the table. One or more cameras external to multi-touch display surface 1202 may be used by processing electronics 1204 for such logic. In other embodiments, RFID-based tracking or other camera-less tracking technology may be used.

Referring further to FIG. 13, processing electronics 1204 are shown to include a processor 1312 and memory 1314. Processor 1312 may be a general purpose or specific purpose processor configured to execute computer code or instructions stored in the memory or received from other computer readable media (e.g., CDROM, network storage, a remote server, etc.). Memory 1314 may be RAM, hard drive storage, temporary storage, non-volatile memory, flash memory, optical memory, or any other suitable memory for storing software objects and/or computer instructions. When processor 1312 executes instructions stored in memory for completing the various activities described herein, processor 1312 generally configures processing circuit 1204 to complete such activities. Stated another way, processor 1312 is configured to execute computer code stored in memory 1314 to complete and facilitate the activities described herein. Memory 1314 is shown to include modules which are computer code modules (e.g., executable code, object code, source code, script code, machine code, etc.) configured for executing by processor 1312. Processing electronics 1204 may include other hardware circuitry for supporting the execution of the computer code of memory 1314.

Regarding further to FIG. 13, memory 1314 is shown to include a BMS module 1316. BMS module 1316 is configured to generate BMS content (e.g., including graphics and text descriptive of BMS data) for GUI 1300. Memory 1314 is further shown to include a surface control module 1318. Surface control module 1318 is configured to cause GUI 1300 and the content generated by BMS module 1316 to be rendered and displayed on multi-touch display surface 1202. Surface control module 1318 is further configured to interpret multiple simultaneous touch inputs received at the touch sensitive surface and to manipulate GUI 1300 based on the interpretation of the multiple simultaneous touch inputs. When BMS module 1316 provides multiple interface windows or objects to the GUI, surface control module 1318 is configured to interpret the multiple simultaneous touch inputs to cause separate manipulations (e.g., multi-user manipulations, simultaneous manipulations, etc.) of the multiple interface windows or objects. BMS module 1316 may be configured to provide the multiple interface windows or objects to GUI 1300 by rending the multiple interface windows or objects using a common graphical theme (e.g., common graphics resources, etc.). Processing electronics 1204 may also include or be coupled to communications electronics configured to receive inputs for processing electronics 1204 from, e.g., at least one of a BMS server and a client device for the BMS. Processing electronics 1204 may be configured to update GUI 1300 provided to multi-touch display surface 1202 based on the inputs received at the communications electronics. BMS module 1316 may further be configured to update data that affects at least one of a setting for and performance of BMS equipment (e.g., security equipment, facility access equipment, HVAC equipment, etc.).

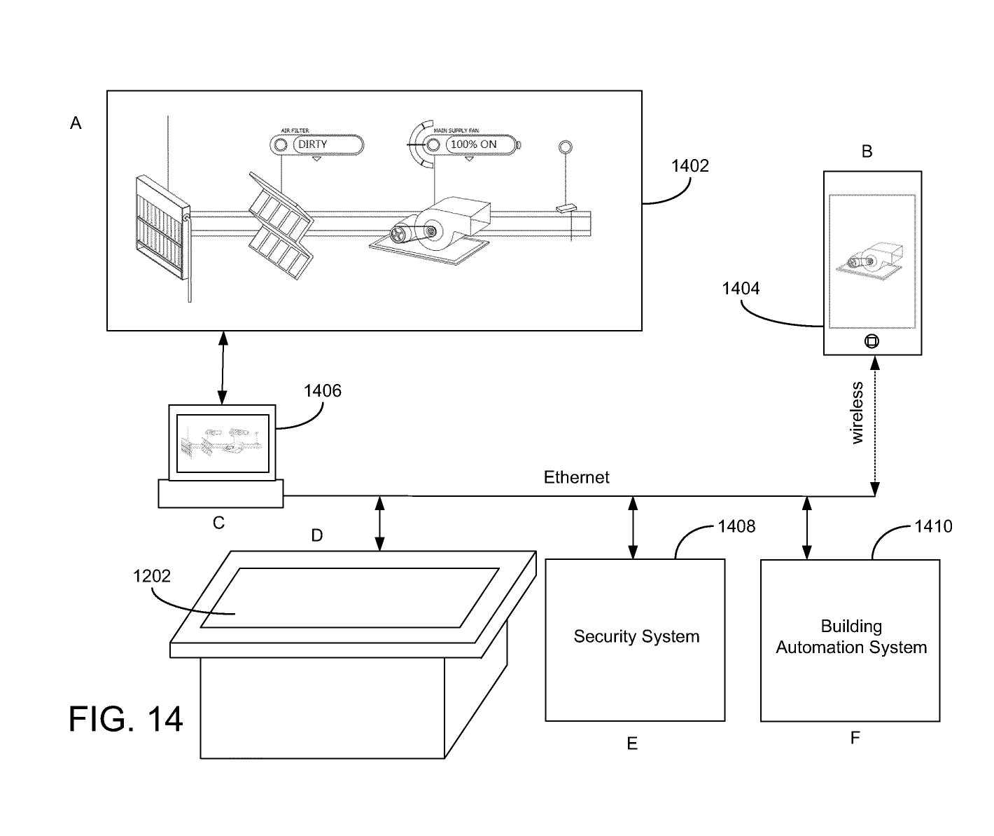

Referring now to FIG. 14, multi-touch display surface 1202 and its associated processing electronics shown as Component D is communicably coupled (e.g., for data communications, via a wireless link, etc.) to multiple other devices. The other devices may include portable electronic devices such as mobile phones, personal digital assistants, laptop computers and the like. Component A is a vertical wall-mounted (or vertical free-standing) multi-touch display surface 1402 that is connected to a host computer C 1406 (e.g., that houses the processing electronics for Component A). Component B is a handheld computer 1404 (e.g., mobile phone, personal digital assistant, netbook, portable electronic device, etc.). The processing electronics of each devices 1202, 1404, 1406 may be configured with processes that update the GUIs shown on those displays such that each of the devices concurrently (or close-in time) display the conditions of, e.g., security system E 1408, building automation system F 1410, etc.

Referring further to FIGS. 12-14, a system for providing a graphical user interface for a building management system includes a display including a touch sensitive surface and processing electronics. The processing electronics includes a BMS module for generating BMS content (e.g., graphics and text descriptive of BMS data for the GUI). The processing electronics also includes a surface control module for causing the GUI and content generated by the BMS module to be rendered and displayed on the display. The surface control module may interpret multiple simultaneous touch inputs received at the touch sensitive surface and manipulate the GUI based on the interpretation of the inputs.

The construction and arrangement of the systems and methods as shown in the various exemplary embodiments are illustrative only. Although only a few embodiments have been described in detail in this application, many modifications are possible. For example, the position of elements may be varied and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present application.

The present application contemplates methods, systems and program products on any machine-readable media for accomplishing various operations. The embodiments of the present application may be implemented using existing computer processors, or by a special purpose computer processor for an appropriate system, incorporated for this or another purpose, or by a hardwired system. Embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

1. A system for displaying a graphical user interface for a building management system on an electronic display for a client device, the system comprising:
a processing circuit configured to load and present a graphical control element within the graphical user interface, wherein the processing circuit further comprises:
(a) an input handler for the graphical control element configured to interpret user inputs received at the client device as commands for the graphical control element;
(b) a data interface for the graphical control element configured to associate the graphical control element with data from disparate building management system sources; and
(c) a data analysis module for the graphical control element configured to use data from the data interface to perform at least one data analysis task;
wherein the processing circuit is further configured to provide results of the data analysis task to the graphical control element for display on the electronic display.

2. The system of claim 1, wherein the processing circuit is configured to provide the results to the graphical control element by changing a graphical indicator visible on the graphical control element, wherein the graphical indicator is at least one of a gauge, a graph, a graphical representation of a piece of building equipment, or a graphical representation of a temperature sensor.

3. The system of claim 1, wherein the electronic display has a touch sensitive surface and the processing circuit further comprises a surface control module configured to interpret multiple simultaneous touch inputs received at the touch sensitive surface and to manipulate the displayed graphical control element based on the interpretation of the multiple simultaneous touch inputs.

4. The system of claim 1, wherein the disparate building management system sources comprise data from at least two different pieces of BMS equipment, two different building subsystems, or two independent building subsystems.

5. The system of claim 4, wherein the two different building subsystems comprise at least two of: an HVAC system, a security system, a building scheduling system, a video system, an IT system, a ventilation system, an air quality system, a cooling system, a heating system, an occupancy system, and an access control system.

6. The system of claim 1, wherein the graphical control element further comprises indicia that identify at least one of the data and the equipment that generated the data used by the data analysis component, or the data and the feature that generated the data used by the data analysis component.

7. The system of claim 1, wherein the graphical control element is configured to display a plurality of data points relevant to a piece of building management system equipment.

8. The system of claim 1, wherein the graphical control element is configured to display a performance index for a piece of building management system equipment based on the analysis task.

9. The system of claim 1, wherein the processing circuit is configured to present a plurality of graphical control elements within the graphical user interface by recalling common presentation resources from a memory device.

10. The system of claim 1, wherein the graphical control element comprises an instantiated object having the input handler, the data interface, and the data analysis module as methods or properties of the object.

11. The system of claim 1, wherein the graphical control element comprises a graphic having one or more input controls and one or more output areas; and wherein the input handler is configured to interpret user inputs received at the one or more input controls; and wherein the graphical control element comprises a module configured to update the one or more output areas based on the results provided by the analysis task.

12. The system of claim 1, wherein the processing circuit is local to the client device and is configured to render the graphical user interface and to provide the graphical user interface to the electronic display; and wherein the data interface is configured to receive real-time data from the building management system.

13. The system of claim 12, wherein the data analysis module is configured to perform a multi-stage analysis using the real-time data.

14. The system of claim 13, wherein the data analysis module performs the multi-stage analysis using the real-time data by generating a predictive model and comparing the real-time data to the predictive model.

15. The system of claim 14, wherein providing results of the data analysis task to the graphical control element for display on the electronic display comprises displaying at least one preventative measure or maintenance task.

16. The system of claim 12, wherein the data analysis module is configured to generate a trend using time-series data and to detect deviations from the trend by comparing the real-time data to the trend.

17. The system of claim 1, wherein at least one of the client and the processing circuit are local to a server that provides information for generating the GUI to the client device.

18. The system of claim 1, wherein a change to a user input control of the graphical control element is recognized by the input handler and provided to at least one of an automation module and a data value configured to cause a change to equipment of the building management system.

19. Computer-readable media with computer-executable instructions embodied thereon that when executed by a computer system perform a method for displaying a graphical user interface for a building management system on an electronic display for a client device, wherein the instructions comprise:
instructions for loading and presenting a graphical control element within the graphical user interface;
instructions for providing an input handler configured to interpret user inputs received at the client device as commands for the graphical control element;
instructions for providing a data interface for the graphical control element configured to associate the graphical control element with data from disparate building management system sources;
instructions for providing a data analysis module for the graphical control element configured to use data from the data interface to perform at least one data analysis task; and
instructions for providing results of the data analysis task to the graphical control element and causing the display of the results on the electronic display.

20. A computerized method for displaying a graphical user interface for a building management system on an electronic display for a client device, comprising:
loading a graphical control element within the graphical user interface;
interpreting user inputs received at the client device as commands for the graphical control element;
associating the graphical control element with data from disparate building management system sources;
performing at least one data analysis task on the graphical control element using data received from the disparate building system and using a data analysis module for the graphical control element; and
causing the data analysis module to provide the results of the data analysis task to the graphical control element and causing the display of the results on the electronic display.
